(19) United States
(12) Patent Application Publication
(10) Pub. No.: US 2018/0178802 A1
(43) Pub. Date: Jun. 28, 2018

(54) DRIVING ASSISTANCE APPARATUS

(71) Applicant: TOYOTA JIDOSHA KABUSHIKI KAISHA, Toyota-shi (JP)

(72) Inventor: Shunsuke MIYATA, Susono-shi (JP)

(73) Assignee: TOYOTA JIDOSHA KABUSHIKI KAISHA, Toyota-shi (JP)

(21) Appl. No.: 15/848,887

(22) Filed: Dec. 20, 2017

(30) Foreign Application Priority Data
Dec. 28, 2016 (JP) 2016-255105

(51) Int. Cl. B60W 30/18; B62D 15/02

(52) U.S. Cl. CPC B60W 30/18163; B62D 15/0255; B60W 2420/52; B62D 5/04; B60W 2710/207; B60W 2710/06; B60W 2710/18; B60W 2550/10

(57) ABSTRACT

A driving assistance apparatus includes a radar sensor and an electronic control unit. The radar sensor is configured to acquire object information for each proximal object that is an object being present in the proximity of a host vehicle. The object information includes a relative speed with respect to the host vehicle and a position with respect to the host vehicle. The electronic control unit is configured to execute lane change assistance control, perform a determination by using the relative speed, forbid execution of the lane change assistance control when the electronic control unit determines that a first execution permission condition is not satisfied, determine whether or not a predetermined second execution permission condition is satisfied, and forbid execution of the lane change assistance control when the electronic control unit determines that the second execution permission condition is not satisfied.

INCORPORATION BY REFERENCE

The disclosure of Japanese Patent Application No. 2016-255105 filed on Dec. 28, 2016 including the specification, drawings and abstract is incorporated herein by reference in its entirety.

### BACKGROUND

### 1. Technical Field

The present disclosure relates to a driving assistance apparatus having a function of assisting traveling of a host vehicle for changing a lane from a host lane that is a lane in which the host vehicle is traveling, to an adjacent target lane that is a lane adjacent to the host lane.

### 2. Description of Related Art

A driving assistance apparatus executing control (that is, lane change assistance control) that automatically changes the steering angle of a steering wheel to assist a steering operation of a driver when the driver changes a lane of a host vehicle, is suggested in the related art. One example of the related art is executing the lane change assistance control when the driver intending to change the lane is recognized based on the operating state of a blinker lever (indicator lever) (refer to, for example, Japanese Unexamined Patent Application Publication No. 2009-274594 (JP 2009-274594 A) (paragraph 0027, paragraph 0029, and paragraph 0053)). The example of the related art forbids the lane change assistance control when, for example, there is no lane on the side to which the driver intends to change the lane, or when the host vehicle continuing to travel has a possibility of collision.

### SUMMARY

When the driving assistance apparatus starts the lane change assistance control, the driving assistance apparatus determines whether or not the host vehicle can smoothly change the lane in a circumstance in the proximity of the host vehicle (that is, determines whether or not to execute the lane change assistance control). The determination is performed based on object information that includes the relative speed of a proximal object with respect to the host vehicle and the position of the proximal object with respect to the host vehicle. The proximal object is an object that is present in the proximity of the host vehicle. The object information is acquired by a radar sensor.

According to a review performed by the inventors, it is confirmed that the accuracy of the relative speed may not be high for an object of which the magnitude of the relative speed included in the object information is low (hereinafter, referred to as a “low relative speed object”). Such tendency is noticeable when the low relative speed object is positioned in the vicinity of the host vehicle. It is considered that the low relative speed object has a large surface reflecting the electric wave radiated by the radar sensor and that the position of the reflecting surface is significantly moved frequently. For example, when the host vehicle is about to change the lane to a right lane, another vehicle as the low relative speed object that is traveling in the right lane in substantially parallel with the host vehicle may reflect the radar wave on a side of the other vehicle at a certain time point and may reflect the radar wave behind the other vehicle at the subsequent time point. Consequently, the “relative speed of the other vehicle” detected by the radar sensor is significantly changed.

The determination as to whether or not to perform the lane change assistance control is desirably performed in the viewpoint of whether or not the host vehicle approaches excessively close to a preceding vehicle in the adjacent target lane and/or whether or not a rear vehicle in the target lane approaches excessively close to the host vehicle. Such a determination is mostly performed based on, for example, a parameter correlated with a time period (so-called TTC) acquired by dividing the distance between the host vehicle and the preceding vehicle by the relative speed of the preceding vehicle, and/or a parameter correlated with a time period acquired by dividing the distance between the host vehicle and the rear vehicle by the relative speed of the rear vehicle. Furthermore, such a determination may include a determination as to whether or not the inter-vehicle distance is sufficiently long when the host vehicle is at the closest point to the preceding vehicle and/or the rear vehicle. In order to acquire the inter-vehicle distance, the relative speed of the preceding vehicle and/or the rear vehicle has to be used.

When the determination is performed by using the relative speed, the accuracy of the determination is not high when the low relative speed object having an inaccurate relative speed is present in the proximity of the host vehicle. Thus, execution of the lane change assistance control may be permitted in a circumstance in which execution of the lane change assistance control is not desired, or execution of the lane change assistance control may be repeatedly permitted and forbidden.

The present disclosure provides a driving assistance apparatus that can accurately determine whether or not to perform lane change assistance control for a low relative speed object and thus, can reduce the possibility or the like of performing the lane change assistance control under a circumstance in which the lane change assistance control should not be performed.

An aspect of the present disclosure relates to a driving assistance apparatus (hereinafter, referred to as the “present disclosed apparatus”) including a radar sensor and an electronic control unit. The radar sensor is configured to acquire object information for each proximal object that is an object being present in the proximity of a host vehicle. The object information includes a relative speed with respect to the host vehicle and a position with respect to the host vehicle. The electronic control unit is configured to execute lane change assistance control that controls a steering angle of the host vehicle to assist traveling of the host vehicle for changing a lane from a host lane to an adjacent target lane. The host lane is a lane in which the host vehicle is traveling, and the adjacent target lane is a lane adjacent to the lane in which the host vehicle is traveling. The electronic control unit is configured to determine whether or not the proximal object satisfies a first execution permission condition for permitting execution of the lane change assistance control, by using at least the relative speed included in the object information. The electronic control unit is configured to forbid execution of the lane change assistance control when the electronic control unit determines that the first execution permission condition is not satisfied. The electronic control unit is configured to determine whether or not a predetermined second execution permission condition is satisfied for a low relative speed object of which a magnitude of the relative speed included in the object information is less than or equal to a predetermined threshold relative speed, by using the position of the low relative speed object included in the object information without using the relative speed of the low relative speed object included in the object information. The electronic control unit is configured to forbid execution of the lane change assistance control when the electronic control unit determines that the second execution permission condition is not satisfied.

The apparatus of the aspect of the present disclosure determines whether or not the first execution permission condition for permitting execution of the lane change assistance control is satisfied, based on the relative speed acquired by the radar sensor. As described above, when a determination as to whether or not the first execution permission condition is established for the low relative speed object is performed by using the relative speed, the determination results in an erroneous determination since the accuracy of the relative speed is not high. Thus, lane change control may be erroneously executed or not executed when the lane change control should be executed.

Therefore, the electronic control unit is configured to determine whether or not the predetermined second execution permission condition is satisfied for the low relative speed object of which the magnitude of the relative speed included in the object information is less than or equal to the predetermined threshold relative speed, by using the position of the low relative speed object included in the object information without using the relative speed of the low relative speed object included in the object information. The electronic control unit is configured to forbid execution of the lane change assistance control when the electronic control unit determines that the second execution permission condition is not satisfied. The second execution permission condition is also a condition that is established when execution of the lane change assistance control may be permitted.

Accordingly, since a determination as to whether or not the second execution permission condition is satisfied for the low relative speed object is performed by using the position without using the relative speed, the accuracy of the determination as to whether or not the second execution permission condition is established is high even when the accuracy of the relative speed is not high. Consequently, even when the low relative speed object is present in the vicinity of the host lane, the “possibility of erroneously executing the lane change control or not executing the lane change control when the lane change control should be executed” can be further decreased.

Other objects, other features, and subsidiary advantages of the present disclosure will be easily understood from the following description of an embodiment of the present disclosure described with reference to the drawings.

### BRIEF DESCRIPTION OF THE DRAWINGS

Features, advantages, and technical and industrial significance of exemplary embodiments of the present disclosure will be described below with reference to the accompanying drawings, in which like numerals denote like elements, and wherein:

FIG. 1 is a schematic configuration diagram of a driving assistance apparatus according to an embodiment;

FIG. 2 is a plan view of a host vehicle illustrating positions in which proximity radar sensors illustrated in FIG. 1 are disposed;

FIG. 3 is a plan view of a host vehicle and a road for describing lane keeping control;

FIG. 4 is a flowchart illustrating a routine executed by a CPU of a driving assistance ECU illustrated in FIG. 1;

FIG. 5 is a plan view of a host vehicle and the proximity thereof for describing a method of selecting a determination target object;

FIG. 6A is a diagram for describing a method of acquiring the shortest inter-vehicle distance between a host vehicle and a preceding vehicle when the host vehicle changes a lane;

FIG. 6B is a diagram for describing a method of acquiring the shortest inter-vehicle distance between a host vehicle and a preceding vehicle when the host vehicle changes a lane;

FIG. 6C is a diagram for describing a method of acquiring the shortest inter-vehicle distance between a host vehicle and a preceding vehicle when the host vehicle changes a lane;

FIG. 7A is a plan view of a host vehicle and the proximity thereof for describing an instantaneous distance condition;

FIG. 7B is a plan view of a host vehicle and the proximity thereof for describing the instantaneous distance condition;

FIG. 8A is a plan view of a host vehicle and the proximity thereof for describing a low relative speed object condition;

FIG. 8B is a plan view of a host vehicle and the proximity thereof for describing the low relative speed object condition;

FIG. 9A is a diagram for describing a method of acquiring the shortest inter-vehicle distance between a host vehicle and a rear vehicle when the host vehicle changes a lane;

FIG. 9B is a diagram for describing a method of acquiring the shortest inter-vehicle distance between a host vehicle and a rear vehicle when the host vehicle changes a lane;

FIG. 10 is a flowchart illustrating a routine executed by the CPU of the driving assistance ECU illustrated in FIG. 1;

FIG. 11 is a flowchart illustrating a routine executed by the CPU of the driving assistance ECU illustrated in FIG. 1; and

FIG. 12 is a flowchart illustrating a routine executed by the CPU of the driving assistance ECU illustrated in FIG. 1.

### DETAILED DESCRIPTION OF EMBODIMENTS

Hereinafter, a driving assistance apparatus according to an embodiment (hereinafter, referred to as the “present embodied apparatus”) will be described with reference to the drawings. The present embodied apparatus is a vehicle traveling control apparatus and is also a driving assistance control apparatus.

Configuration

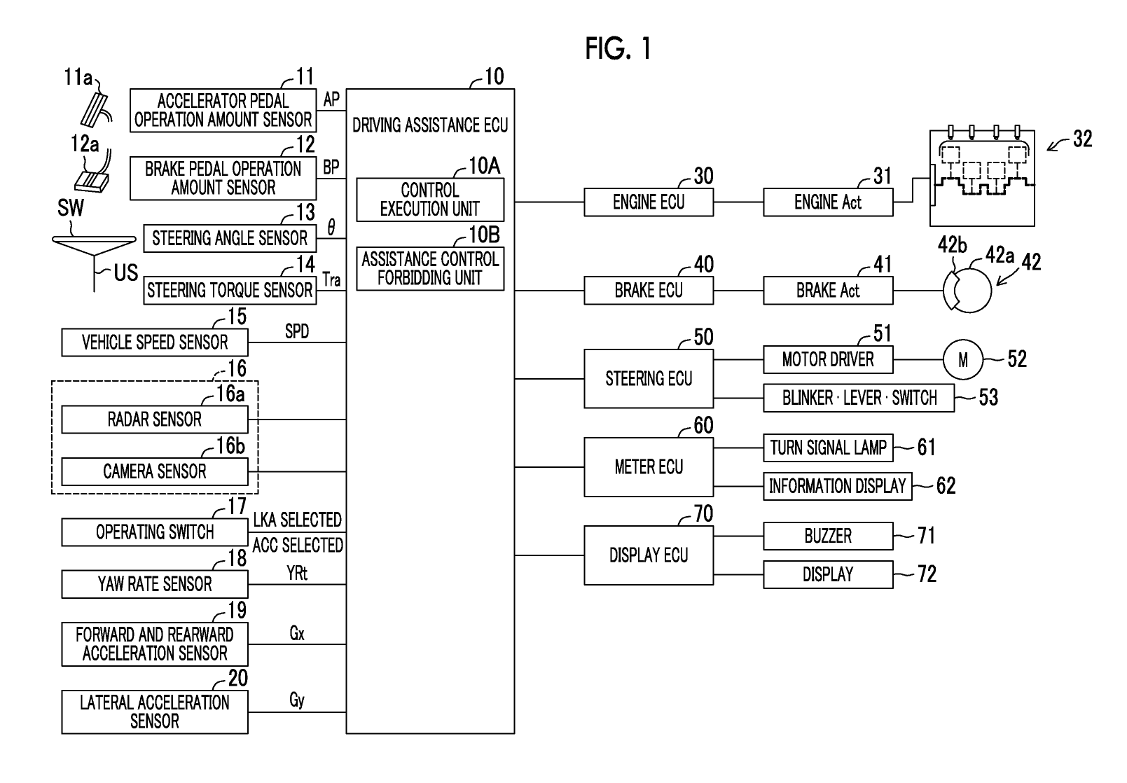

As illustrated in FIG. 1, the present embodied apparatus is applied to a vehicle (hereinafter, referred to as a “host vehicle” for distinction from other vehicles) and includes a driving assistance ECU 10, an engine ECU 30, a brake ECU 40, a steering ECU 50, a meter ECU 60, a display ECU 70, and a navigation ECU 80.

Each ECU is an electric control unit including a microcomputer as a main part and is connected to each other through a controller area network (CAN), not illustrated, in a manner capable of transmitting and receiving information with each other. In the present specification, the microcomputer includes a CPU, a ROM, a RAM, a non-volatile memory, an interface I/F, and the like. The CPU realizes various functions by executing instructions (programs and routines) stored in the ROM. Several ECUs or all of the ECUs may be combined into one ECU.

The driving assistance ECU 10 is connected to sensors (include switches) described below and receives detection signals or output signals of the sensors. Each sensor may be connected to an ECU other than the driving assistance ECU 10. In such a case, the driving assistance ECU 10 receives the detection signals or the output signals of the sensors through the CAN from the ECU to which the sensors are connected.

An accelerator pedal operation amount sensor 11 detects the operation amount of an accelerator pedal 11a (accelerator operation amount) of the host vehicle and outputs a signal representing an accelerator pedal operation amount AP. A brake pedal operation amount sensor 12 detects the operation amount of a brake pedal 12a of the host vehicle and outputs a signal representing a brake pedal operation amount BP.

A steering angle sensor 13 detects the steering angle of the host vehicle and outputs a signal representing a steering angle θ. A steering torque sensor 14 detects steering torque that is exerted on a steering shaft US of the host vehicle by operating a steering wheel SW, and outputs a signal representing steering torque Tra. A vehicle speed sensor 15 detects the traveling speed (vehicle speed) of the host vehicle and outputs a signal representing a vehicle speed Vsx. That is, the vehicle speed Vsx is the speed (that is, a longitudinal speed) of the vehicle in the front-rear direction (a direction along a center axis line extending in the front-rear direction of the host vehicle).

A proximity sensor 16 includes a proximity radar sensor 16a and a camera sensor 16b.

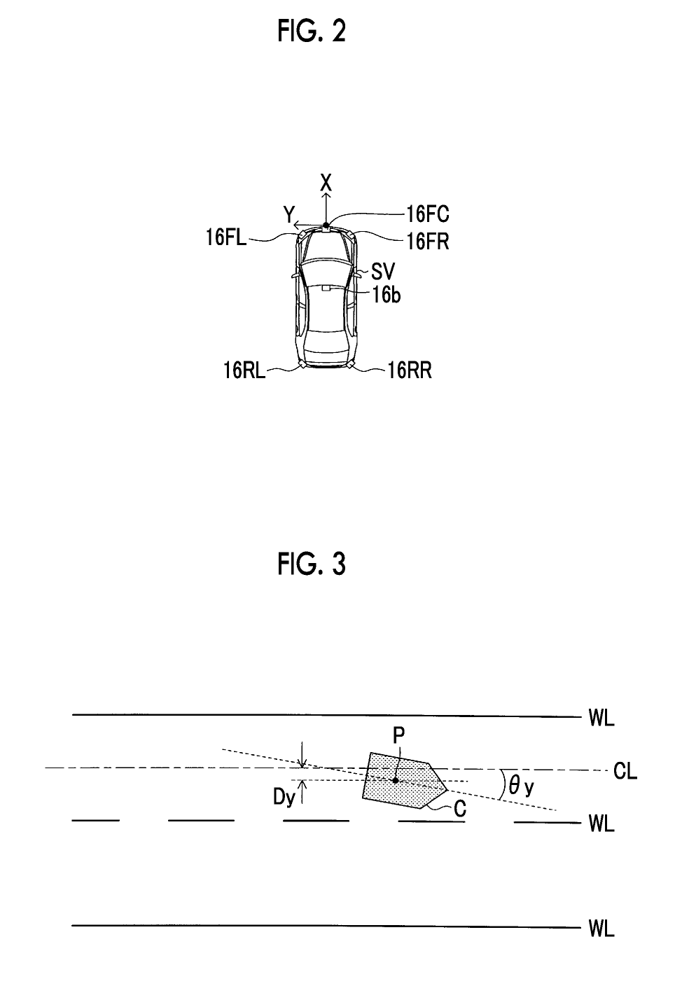

As illustrated in FIG. 2, the proximity radar sensor 16a includes a front center proximity sensor 16FC, a front right proximity sensor 16FR, a front left proximity sensor 16FL, a rear right proximity sensor 16RR, and a rear left proximity sensor 16RL. When the proximity sensors 16FC, 16FR, 16FL, 16RR, 16RL do not have to be distinguished from each other, the proximity sensors 16FC, 16FR, 16FL, 16RR, 16RL will be referred to as the proximity radar sensor 16a. The proximity sensors 16FC, 16FR, 16FL, 16RR, 16RL have substantially the same configuration.

The proximity radar sensor 16a includes a radar transmission and reception unit and a signal processing unit (not illustrated). The radar transmission and reception unit radiates an electric wave in a millimeter wave band (hereinafter, referred to as a “millimeter wave”) and receives a millimeter wave reflected by a three-dimensional body (for example, another vehicle, a pedestrian, a bicycle, or a building) being present within a radiation range of the radar transmission and reception unit (that is, a reflective wave). The signal processing unit acquires information representing the distance between the host vehicle and the three-dimensional body, the relative speed between the host vehicle and the three-dimensional body, the azimuth of the three-dimensional body with respect to the host vehicle, and the like for each elapse of a predetermined time period based on the difference in phase between the transmitted millimeter wave and the received reflective wave, the difference in frequency between the transmitted millimeter wave and the received reflective wave, the attenuation level of the reflective wave, the time period from the transmission of the millimeter wave to the reception of the reflective wave, and the like. The signal processing unit supplies the information to the driving assistance ECU 10. The driving assistance ECU 10 specifies the position of the three-dimensional body with respect to the host vehicle from the distance between the host vehicle and the three-dimensional body and the azimuth of the three-dimensional body with respect to the host vehicle. The driving assistance ECU 10 can detect a front-rear direction component (longitudinal distance) and a lateral direction component (lateral distance) of the distance between the host vehicle and the three-dimensional body and a front-rear direction component (longitudinal relative speed) and a lateral direction component (lateral relative speed) of the relative speed between the host vehicle and the three-dimensional body by using the proximity information. When the term relative speed is used, the relative speed means the longitudinal relative speed.

As illustrated in FIG. 2, the front center proximity sensor 16FC is disposed in a front center portion of a vehicle body and detects a three-dimensional body that is present in a region in front of the host vehicle. The front right proximity sensor 16FR is disposed in a front right corner portion of the vehicle body and mainly detects a three-dimensional body that is present in a region in the right front of the host vehicle. The front left proximity sensor 16FL is disposed in a front left corner portion of the vehicle body and mainly detects a three-dimensional body that is present in a region in the left front of the host vehicle. The rear right proximity sensor 16RR is disposed in a rear right corner portion of the vehicle body and mainly detects a three-dimensional body that is present in a region at the right rear of the host vehicle. The rear left proximity sensor 16RL is disposed in a rear left corner portion of the vehicle body and mainly detects a three-dimensional body that is present in a region at the left rear of the host vehicle. For example, the proximity radar sensor 16a detects a three-dimensional body that enters within a range having a distance of approximately 100 meters from the host vehicle. Hereinafter, the three-dimensional body detected by the proximity radar sensor 16a may be referred to as an “object”. Information that represents the “position with respect to the host vehicle (that is, the relative position) and the speed with respect to the host vehicle (that is, the relative speed)” of the object detected by the proximity radar sensor 16a will be referred to as “object information”.

When an object of which the actual relative speed with respect to the host vehicle is low is positioned in the vicinity of the host vehicle, the detection accuracy of the relative speed of the object detected by the proximity radar sensor 16a may be decreased. It is estimated that such an object tends to have a larger size of a radar wave reflecting surface than an object away from the host vehicle and that the position of the radar wave reflecting surface of such an object is frequently moved (that is, the radar wave reflecting surface is not stable). The proximity radar sensor 16a may be a radar sensor that uses an electric wave in a frequency band other than the millimeter wave band.

The camera sensor 16b includes a camera unit and a lane recognition unit.

The camera unit is a stereo camera. The lane recognition unit analyzes image data acquired by imaging with the camera unit and recognizes a white line on the road. The camera sensor 16b (camera unit) images a scene in front of the host vehicle. The camera sensor 16b (lane recognition unit) analyzes the image data of an image processing region having a predetermined angular range (a range spreading in front of the host vehicle) and recognizes (detects) a white line (dividing line) formed on the road in front of the host vehicle. The camera sensor 16b transmits information related to the recognized white line to the driving assistance ECU 10.

As illustrated in FIG. 3, the driving assistance ECU 10 specifies a lane center line CL based on the information supplied from the camera sensor 16b. The lane center line CL is the position of the width direction center between right and left white lines WL in a lane in which the host vehicle is traveling (hereinafter, referred to as a “host lane”). The lane center line CL is used as a target traveling line in lane keeping assistance control described below. The driving assistance ECU 10 calculates a curvature Cu of a curve of the lane center line CL.

The driving assistance ECU 10 calculates the position and the direction of the host vehicle in the lane divided by the left white line and the right white line. For example, as illustrated in FIG. 3, the driving assistance ECU 10 calculates a distance Dy in the road width direction between a reference point P (for example, the position of the center of gravity) of a host vehicle C and the lane center line CL. The distance Dy is the length indicating the amount of deviation of the host vehicle C from the lane center line CL in the road width direction. Hereinafter, the distance Dy will be referred to as a “lateral deviation Dy”.

The driving assistance ECU 10 calculates an angle θy between the direction of the lane center line CL and the direction in which the host vehicle C moves. Hereinafter, the angle θy will be referred to as a “yaw angle θy”. Hereinafter, information that represents the curvature Cu, the lateral deviation Dy, and the yaw angle θy (Cu, Dy, θy) may be referred to as “lane-related vehicle information”.

The camera sensor 16b supplies information as to the type of each of the left white line and the right white line of the host lane (for example, a solid line or a broken line), the shape of each white line, and the like to the driving assistance ECU 10. The camera sensor 16b supplies information as to the type of each of a left white line and a right white line of a lane adjacent to the host lane, the shape of each white line, and the like to the driving assistance ECU 10. That is, the camera sensor 16b supplies “information related to the white line” to the driving assistance ECU 10. When the white line is a solid line, the vehicle is forbidden from changing the lane across the white line. When the white line is a broken line (white lines discontinuously formed at certain intervals), the vehicle is permitted to change the lane across the white line. The lane-related vehicle information (Cu, Dy, θy) and the information related to the white line may be referred to as “lane information”.

While the driving assistance ECU 10 calculates the lane-related vehicle information (Cu, Dy, θy) in the present embodiment, the camera sensor 16b may calculate the lane-related vehicle information (Cu, Dy, θy) and supply the calculation result to the driving assistance ECU 10.

Returning to FIG. 1, an operating switch 17 is an operating unit that is operated by a driver in order to select whether or not to execute each of “lane change assistance control, lane keeping assistance control, and inter-vehicle following distance control” described below. Accordingly, in accordance with the operation of the operating switch 17 by the driver, the operating switch 17 outputs a signal indicating whether or not execution of each control is selected. The operating switch 17 also functions to cause the driver to input or select a parameter (for example, an inter-vehicle time period described below) for reflecting the preference of the driver when the driver executes each control.

The driving assistance ECU 10 determines whether or not execution of the inter-vehicle following distance control is selected, based on the signal supplied from the operating switch 17. When execution of the inter-vehicle following distance control is not selected, the driving assistance ECU 10 does not execute the lane change assistance control and the lane keeping assistance control. The driving assistance ECU 10 determines whether or not execution of the lane keeping assistance control is selected, based on the signal supplied from the operating switch 17. When execution of the lane keeping assistance control is not selected, the driving assistance ECU 10 does not execute the lane change assistance control.

A yaw rate sensor 18 detects a yaw rate YRt of the host vehicle and outputs the actual yaw rate YRt. The actual yaw rate YRt has a positive value when the host vehicle is making a left turn while traveling forward. The actual yaw rate YRt has a negative value when the host vehicle is making a right turn while traveling forward. A forward and rearward acceleration sensor 19 detects an acceleration Gx in the front-rear direction of the host vehicle and outputs the actual forward and rearward acceleration Gx. The actual forward and rearward acceleration Gx has a positive value when the host vehicle is accelerating forward. The actual forward and rearward acceleration Gx has a negative value when the host vehicle is decelerating. A lateral acceleration sensor 20 detects an acceleration Gy in the lateral (vehicle width) direction of the host vehicle (a direction that is orthogonal with respect to the center axis line of the host vehicle) and outputs the actual lateral acceleration Gy. The actual lateral acceleration Gy has a positive value when the host vehicle is making a left turn while traveling forward (that is, an acceleration in the right direction of the vehicle). The actual lateral acceleration Gy has a negative value when the host vehicle is making a right turn while traveling forward (that is, an acceleration in the left direction of the vehicle).

As described above, the driving assistance ECU 10 can execute the inter-vehicle following distance control, the lane keeping control, and the lane change assistance control. Regarding the function of the driving assistance ECU 10, the driving assistance ECU 10 includes a control execution unit 10A and an assistance control forbidding unit 10B. The control execution unit 10A executes each control. The assistance control forbidding unit 10B permits or forbids execution of the lane change assistance control.

The engine ECU 30 is connected to an engine actuator 31. The engine actuator 31 is an actuator for changing the operating state of an internal combustion engine 32. In the present example, the internal combustion engine 32 is a gasoline fuel injection spark-ignition multi-cylinder engine and includes a throttle valve for adjusting the amount of air intake. The engine actuator 31 includes at least a throttle valve actuator that changes the opening degree of the throttle valve. The engine ECU 30 can change torque generated by the internal combustion engine 32 by driving the engine actuator 31. The torque generated by the internal combustion engine 32 is transmitted to a drive wheel, not illustrated, through a transmission not illustrated. Accordingly, the engine ECU 30 can control drive power of the host vehicle and change the acceleration state (acceleration) of the host vehicle by controlling the engine actuator 31.

The brake ECU 40 is connected to a brake actuator 41. The brake actuator 41 is disposed in a hydraulic pressure circuit between a master cylinder, not illustrated, and a friction brake mechanism 42. The master cylinder pressurizes hydraulic oil by force of stepping on the brake pedal. The friction brake mechanism 42 is disposed at front and rear wheels on the right and left sides. The friction brake mechanism 42 includes a brake disc 42a and a brake caliper 42b. The brake disc 42a is fixed to the wheel. The brake caliper 42b is fixed to the vehicle body. The brake actuator 41 adjusts, in accordance with an instruction from the brake ECU 40, hydraulic pressure supplied to a wheel cylinder incorporated in the brake caliper 42b and operates the wheel cylinder by the hydraulic pressure, thus pressing a brake pad to the brake disc 42a and generating frictional braking power. Accordingly, the brake ECU 40 can control the braking power of the host vehicle by controlling the brake actuator 41.

The steering ECU 50 is a control device for a well-known electric power steering system and is connected to a motor driver 51. The motor driver 51 is connected to a steering motor 52. The steering motor 52 is embedded in a “steering mechanism that includes a steering wheel, a steering shaft connected to the steering wheel, a steering gear mechanism, and the like” in the vehicle. The steering motor 52 generates torque by electric power supplied from the motor driver 51 and thus, can exert steering assist torque or steer the steering wheel rightward or leftward by the torque. That is, the steering motor 52 can change the steering angle (the steering angle of the steering wheel) of the host vehicle.

The steering ECU 50 is connected to a blinker lever switch 53. The blinker lever switch 53 is a detection switch that detects the operating position of a blinker lever which is operated by the driver in order to operate (cause to blink) a turn signal lamp 61 described below.

The blinker lever is disposed in a steering column. The blinker lever can operate in two positions of a first stage position rotated from an initial position by a predetermined angle in a clockwise operation direction and a second stage position rotated from the first stage position by a predetermined rotation angle in the clockwise operation direction. The blinker lever maintains the position thereof as long as the driver maintains the blinker lever in the first stage position in the clockwise operation direction. When the driver releases the blinker lever, the blinker lever automatically returns to the initial position. When the blinker lever is in the first stage position in the clockwise operation direction, the blinker lever switch 53 outputs, to the steering ECU 50, a signal indicating that the blinker lever is maintained in the first stage position in the clockwise operation direction.

The blinker lever can also operate in two positions of a first stage position rotated from the initial position by a predetermined angle in a counterclockwise operation direction and a second stage position rotated from the first stage position by a predetermined rotation angle in the counterclockwise operation direction. The blinker lever maintains the position thereof as long as the driver maintains the blinker lever in the first stage position in the counterclockwise operation direction. When the driver releases the blinker lever, the blinker lever automatically returns to the initial position. When the blinker lever is in the first stage position in the counterclockwise operation direction, the blinker lever switch 53 outputs, to the steering ECU 50, a signal indicating that the blinker lever is maintained in the first stage position in the counterclockwise operation direction. Such a blinker lever is disclosed in, for example, Japanese Unexamined Patent Application Publication No. 2005-138647 (JP 2005-138647 A).

The driving assistance ECU 10 measures a continuous time period in which the blinker lever is held in the first stage position in the clockwise operation direction, based on the signal from the blinker lever switch 53. When the driving assistance ECU 10 determines that the measured continuous time period is longer than or equal to an assistance request confirmation time period (for example, 0.8 seconds) set in advance, the driving assistance ECU 10 determines that the driver makes a request for receiving lane change assistance (hereinafter, referred to as a “lane change assistance request”) in order to change the lane to a right lane.

The driving assistance ECU 10 measures a continuous time period in which the blinker lever is held in the first stage position in the counterclockwise operation direction, based on the signal from the blinker lever switch 53. When the driving assistance ECU 10 determines that the measured continuous time period is longer than or equal to the assistance request confirmation time period set in advance, the driving assistance ECU 10 determines that the driver makes a lane change assistance request in order to change the lane to the left lane.

The meter ECU 60 is connected to right and left turn signal lamps 61 (blinker lamps) and an information display 62.

The meter ECU 60 causes the right or left turn signal lamp 61 to blink through a blinker drive circuit, not illustrated, in accordance with the signal from the blinker lever switch 53, an instruction from the driving assistance ECU 10, and the like. For example, when the blinker lever switch 53 outputs a signal indicating that the blinker lever is maintained in the first stage position in the counterclockwise operation direction, the meter ECU 60 causes the left turn signal lamp 61 to blink. When the blinker lever switch 53 outputs a signal indicating that the blinker lever is maintained in the first stage position in the clockwise operation direction, the meter ECU 60 causes the right turn signal lamp 61 to blink.

The information display 62 is a multi-information display that is disposed in front of a driving seat. The information display 62 displays measured values such as the vehicle speed and the engine rotational speed and various types of information. For example, when the meter ECU 60 receives a display instruction corresponding to the state of driving assistance from the driving assistance ECU 10, the meter ECU 60 displays a screen specified by the display instruction on the information display 62.

The display ECU 70 is connected to a buzzer 71 and a display 72. The display ECU 70 can call attention of the driver by ringing the buzzer 71 in accordance with an instruction from the driving assistance ECU 10. The display ECU 70 can cause the display 72 to light an attention calling mark (for example, a warning lamp) or display an alert image, a warning message, or the status of operation of driving assistance control on the display 72 in accordance with an instruction from the driving assistance ECU 10. The display 72 is a head-up display and may be a display of another type.

Basic Summary of Driving Assistance Control

As described above, the driving assistance ECU 10 can execute the inter-vehicle following distance control, the lane keeping control, and the lane change assistance control. Hereinafter, a summary of each control will be described.

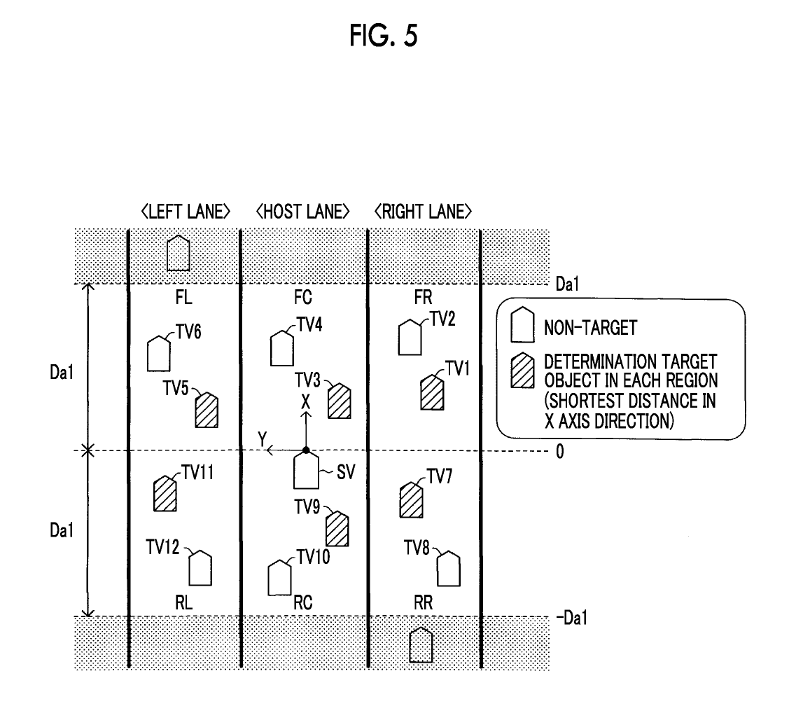

The driving assistance ECU 10 defines an X-Y coordinate plane in order to execute each control (refer to FIG. 2 and FIG. 5). The X axis is a coordinate axis that extends in the front-rear direction of the host vehicle SV to pass through the position of the width direction center of a front end portion of the host vehicle SV. The front of the host vehicle SV has a positive value on the coordinate axis. The Y axis is a coordinate axis that is orthogonal with respect to the X axis. The left direction of the host vehicle SV has a positive value on the coordinate axis. The origin of the X axis and the origin of the Y axis are the position of the width direction center of the front end portion of the host vehicle SV.

The driving assistance ECU 10 acquires a longitudinal distance Dfx(n), a relative speed Vfx(n), an azimuth H(n), and the like with respect to each detected object (n) from the proximity sensor 16 for each elapse of a predetermined time period.

The inter-vehicle distance Dfx(n) is the distance between the host vehicle and the object (n) (for example, a preceding vehicle) in the X axis direction and is referred to as a longitudinal distance. The relative speed Vfx(n) is the difference between a speed Vtx of the object (n) (for example, the preceding vehicle) and a speed Vsx of a host vehicle VA (=Vtx−Vsx). The speed Vtx of the object (n) is the speed of the object (n) in the X axis direction. The azimuth H(n) is the angle between the center axis line of the host vehicle and a line connecting the object (n) with the position of the width direction center of the front end portion of the host vehicle. The azimuth H(n) is set to have a positive value when the object (n) is on the left side of the center axis line of the host vehicle, and is set to have a negative value when the object (n) is on the right side of the center axis line of the host vehicle.

Inter-Vehicle Following Distance Control (ACC)

The inter-vehicle following distance control is control that causes the host vehicle to follow the preceding vehicle while maintaining the inter-vehicle distance between the host vehicle and the preceding vehicle traveling immediately ahead of the host vehicle at a predetermined distance based on the object information. The inter-vehicle following distance control is well-known (refer to, for example, Japanese Unexamined Patent Application Publication No. 2014-148293 (JP 2014-148293 A), Japanese Unexamined Patent Application Publication No. 2006-315491 (JP 2006-315491 A), Japanese Patent No. 4172434 (JP 4172434 B), and Japanese Patent No. 4929777 (JP 4929777 B)). Accordingly, hereinafter, the inter-vehicle following distance control will be briefly described. The inter-vehicle following distance control may be referred to as adaptive cruise control.

When execution of the inter-vehicle following distance control is selected by operating the operating switch 17, the driving assistance ECU 10 executes the inter-vehicle following distance control.

More specifically, when execution of the inter-vehicle following distance control is selected (in actuality, when the vehicle speed Vsx of the host vehicle is within a predetermined range in such a case), the driving assistance ECU 10 selects a following target vehicle based on the object information acquired by the proximity sensor 16. For example, the driving assistance ECU 10 determines whether or not the relative position of the object (n) specified from the azimuth H(n) and the inter-vehicle distance Dfx(n) of the detected object (n) is present within a following target vehicle area that is set in advance such that the absolute value of the azimuth H(n) is decreased as the inter-vehicle distance is increased. When the relative position of the object is present within the following target vehicle area for a predetermined time period or longer, the driving assistance ECU 10 selects the object (n) as a following target vehicle. When there is a plurality of objects being present within the following target vehicle area for the predetermined time period or longer, the driving assistance ECU 10 selects the closest object to the host vehicle (the object having the shortest inter-vehicle distance Dfx(n)) as the following target vehicle.

The driving assistance ECU 10 calculates a target acceleration Gtgt in accordance with any of General Formula (1) and General Formula (2). In General Formula (1) and General Formula (2), Vfx(a) denotes the relative speed of a following target vehicle (a), and k1 and k2 denote predetermined positive gains (coefficients). An inter-vehicle deviation that is acquired by subtracting a “target inter-vehicle distance Dtgt from the inter-vehicle distance Dfx(a) of the following target vehicle (a)” (=Dfx(a)−Dtgt) is denoted by ΔD1. The target inter-vehicle distance Dtgt is calculated by multiplying a target inter-vehicle time period Ttgt by the vehicle speed Vsx of the host vehicle (that is, Dtgt=Ttgt·Vsx). The target inter-vehicle time period Ttgt is set by the driver using the operating switch 17.

The driving assistance ECU 10 determines the target acceleration Gtgt by using General Formula (1) when the value (k1·ΔD1+k2·Vfx(a)) is positive or “0”. In General Formula (1), ka1 denotes a positive gain (coefficient) for acceleration and is set to a value less than or equal to “1”. The driving assistance ECU 10 determines the target acceleration Gtgt by using General Formula (2) when the value (k1·ΔD1+k2·Vfx(a)) is negative. In General Formula (2), kd1 denotes a positive gain (coefficient) for deceleration and is set to “1” in the present example.

Gtgt (for acceleration)=ka1·(k1·ΔD1+k2·Vfx(a)) (1)

Gtgt (for deceleration)=kd1·(k1·ΔD1+k2·Vfx(a)) (2)

When the object is not present in the following target vehicle area, the driving assistance ECU 10 determines the target acceleration Gtgt based on a target speed and the vehicle speed Vsx such that the vehicle speed Vsx of the host vehicle matches the “target speed set in accordance with the target inter-vehicle time period Ttgt”.

The driving assistance ECU 10 controls the engine actuator 31 by using the engine ECU 30 such that the actual forward and rearward acceleration Gx matches the target acceleration Gtgt, and controls the brake actuator 41 by using the brake ECU 40 as needed.

Lane Keeping Control (LKA or LTC)

The lane keeping control is control that changes the steering angle of the host vehicle by imparting steering torque to the steering mechanism to maintain the position of the host vehicle near the target traveling line within the host lane (that is, the lane in which the host vehicle is traveling), thus assisting a steering operation performed by the driver. The lane keeping control is well-known (refer to, for example, Japanese Unexamined Patent Application Publication No. 2008-195402 (JP 2008-195402 A), Japanese Unexamined Patent Application Publication No. 2009-190464 (JP 2009-190464 A), Japanese Unexamined Patent Application Publication No. 2010-6279 (JP 2010-6279 A), and Japanese Patent No. 4349210 (JP 4349210 B)). Accordingly, hereinafter, the lane keeping control will be briefly described. The lane keeping control may be referred to as lane keeping assist (LKA), lane trace control (LTC), and the like.

When execution of the lane keeping control is selected by operating the operating switch 17 during execution of the inter-vehicle following distance control, the driving assistance ECU 10 executes the lane keeping control. More specifically, the driving assistance ECU 10 determines the lane center line CL illustrated in FIG. 3 as a target traveling line Ld. The driving assistance ECU 10 acquires the curvature Cu of the target traveling line Ld (that is, the lane center line CL), the lateral deviation Dy, and the yaw angle θy by calculation.

The driving assistance ECU 10 calculates a target yaw rate YRc* in a predetermined calculation cycle by General Formula (3) based on the lateral deviation Dy, the yaw angle θy, and the curvature Cu of the target traveling line Ld. In General Formula (3), K1, K2, and K3 denote control gains. The target yaw rate YRc* is a yaw rate that is set to enable the host vehicle to travel along the target traveling line Ld.

YRc*=K1×Dy+K2×θy+K3×Cu (3)

The driving assistance ECU 10 calculates target steering torque Tr* for acquiring the target yaw rate YRc* in the predetermined calculation cycle based on the target yaw rate YRc* and the actual yaw rate YRt. More specifically, the driving assistance ECU 10 stores, in advance, a lookup table that defines a relationship between the target steering torque Tr* and the deviation between the target yaw rate YRc* and the actual yaw rate YRt. The driving assistance ECU 10 calculates the target steering torque Tr* by applying the deviation between the target yaw rate YRc* and the actual yaw rate YRt to the table. The driving assistance ECU 10 controls the steering motor 52 by using the steering ECU 50 such that the actual steering torque Tra matches the target steering torque Tr*. Accordingly, the driving assistance ECU 10 executes the lane keeping control that controls the steering angle of the host vehicle to cause the host vehicle to travel along the target traveling line Ld. The driving assistance ECU 10 may directly acquire a target steering angle that is needed to cause the host vehicle to travel along the target traveling line Ld, based on the lane-related vehicle information (Cu, Dy, θy) and the target traveling line Ld. The driving assistance ECU 10 may control the steering motor 52 such that the actual steering angle θ matches the target steering angle.

Lane Change Assistance Control (LCS)

The lane change assistance control is control that changes the steering angle of the host vehicle by imparting steering torque to the steering mechanism to move the host vehicle to an adjacent lane intended by the driver (that is, a target adjacent lane) from the host lane, when the host vehicle is determined to be capable of safely changing the lane based on the circumstance around the host vehicle, thus assisting a steering operation (operating the wheel in order to change the lane) performed by the driver. When the host vehicle is determined to be capable of safely changing the lane based on the circumstance around the host vehicle, the result of an LCS permission/non-permission determination described below indicates that the lane change assistance control may be permitted in the circumstance around the host vehicle. The lane change assistance control may be referred to as “lane change support (LCS)”.

The lane change assistance control is control that adjusts the lateral position (the position in the width direction of the road) of the host vehicle with respect to the lane in the same manner as the lane keeping control. The lane change assistance control is executed instead of the lane keeping control when a “lane change assistance request” is received during execution of the inter-vehicle following distance control and the lane keeping control.

When the driving assistance ECU 10 receives the lane change assistance request, the driving assistance ECU 10 rings the buzzer 71 for a short time period to notify the driver that the lane change assistance request is received. Blinking of the turn signal lamp 61 started by operating the blinker lever is continued by the driving assistance ECU 10.

1. Calculation of Target Trajectory

When the driving assistance ECU 10 executes the lane change assistance control, the driving assistance ECU 10 calculates a target trajectory for changing the lane of the host vehicle based on the lane information at the current point in time supplied from the camera sensor 16b and the vehicle state (for example, the lateral deviation Dy and the vehicle speed Vsx) of the host vehicle at the current point in time. The target trajectory is a trajectory along which the host vehicle is moved through a target lane change time period from the host lane (that is, the original lane) in which the host vehicle is currently traveling, to the position of the width direction center of a lane that is adjacent to the original lane and is in a direction specified by the lane change assistance request (that is, an adjacent target lane), based on the target lane change time period. The position of the width direction center of the target lane is referred to as the “final target lateral position”. The target trajectory is represented by a target lateral position y(t) of the host vehicle with respect to an elapsed time period t from the start time point of the lane change assistance control with the lane center line CL of the original lane (refer to FIG. 3) as a reference.

The target lane change time period is set to be proportional to the distance in which the host vehicle is moved to the final target lateral position in a lateral direction (hereinafter, referred to as a “needed lateral distance”). For example, when the lane width is a general width of 3.5 m, the target lane change time period is set to 8.0 seconds. When the lane width is 4.0 m, the target lane change time period is set to 9.1 seconds (=8.0×4.0/3.5).

When the lateral position of the host vehicle deviates from the lane center line CL of the original lane to the adjacent target lane side at the start of the lane change assistance control, the target lane change time period is set to be decreased as the amount of displacement (the magnitude of the lateral deviation Dy) is larger. When the lateral position of the host vehicle deviates from the lane center line CL of the original lane to the opposite side from the adjacent target lane at the start of the lane change assistance control, the target lane change time period is set to be increased as the amount of displacement (the magnitude of the lateral deviation Dy) is larger. The driving assistance ECU 10 determines the target lane change time period by correcting a reference lane change time period (for example, 8.0 seconds) in accordance with the lane width and the amount of displacement from the lane center line CL of the original lane. The reference lane change time period is a reference value for the target lane change time period.

The driving assistance ECU 10 represents the target lateral position y by the target lateral position function y(t) illustrated in General Formula (4). The lateral position function y(t) is a quintic function that uses the elapsed time period t.

y(t)=a·t⁵+b·t⁴+c·t³+d·t²+e·t+f (4)

The “constants a, b, c, d, e, f” in General Formula (4) are determined based on the traveling state, the lane information, the target lane change time period, and the like of the host vehicle at the time of calculation of the target trajectory. The driving assistance ECU 10 calculates the coefficients a, b, c, d, e, f such that a smooth target trajectory is acquired, by inputting the traveling state, the lane information, and the target lane change time period of the host vehicle stored in advance in the ROM into a vehicle model. The target lateral position at time point t is acquired by substituting the calculated “coefficients a, b, c, d, e, f” and the elapsed time period t from the start of the lane change assistance control in the target lateral position function y(t). The value f in General Formula (4) represents the lateral position of the host vehicle at t=0 (that is, at the start of the lane change assistance control) and thus, is set to a value equal to the lateral deviation Dy.

The target lateral position y can be set by any method other than the method. For example, the target lateral position y does not have to be calculated by using a quintic function such as General Formula (4) and can be acquired by using a function that is arbitrarily set.

2. Control of Steering Angle

The driving assistance ECU 10 executes the lane keeping control before starting the lane change assistance control. In the lane keeping control, the target steering torque Tr* (or the target steering angle) is calculated as described above, and the steering motor 52 is controlled such that the target steering torque Tr* (or the target steering angle) is acquired. The driving assistance ECU 10 performs the same control as the lane keeping control in the lane change assistance control.

That is, the driving assistance ECU 10 performs the lane change assistance control by changing the target traveling line Ld, which is set to match the lane center line CL of the original lane in the lane keeping control, to a line represented by the target lateral position function y(t) in General Formula (4). The driving assistance ECU 10 may acquire the target steering angle in accordance with General Formula (5) and drive the steering motor 52 to acquire the target steering angle.

θlcs*=Klcs1·Cu*+Klcs2·(θy*−θy)+Klcs3·(Dy*−Dy) (5)

In General Formula (5), θy and Dy are values represented by the lane-related vehicle information (Cu, Dy, θy) at current time (at the time of calculation) t. Klcs1, Klcs2, Klcs3, and Klcs4 are control gains. Cu* is the curvature of the target trajectory at current time point t, and θy* is the yaw angle of the target trajectory with respect to the lane center line CL of the original lane at current time point t. Dy* is the lateral deviation of the target trajectory at current time point t (Dy*=y(t)).

Summary of Operation

Next, a summary of operation of the driving assistance ECU 10 of the present embodied apparatus will be described. When the traveling state of the host vehicle is in execution of the lane keeping control, the driving assistance ECU 10 determines whether or not the lane change assistance control may be permitted in the circumstance around the host vehicle. Hereinafter, the determination as to whether or not the lane change assistance control may be permitted in the circumstance around the host vehicle will be referred to as the “LCS permission/non-permission determination”.

When the driving assistance ECU 10 determines that the lane change assistance control may be permitted in the circumstance around the host vehicle as a result of the LCS permission/non-permission determination, and a lane change assistance request is generated, the driving assistance ECU 10 receives the lane change assistance request and starts executing the lane change assistance control. When the driving assistance ECU 10 determines that the lane change assistance control may not be permitted in the circumstance around the host vehicle as a result of the LCS permission/non-permission determination (that is, when it is not appropriate to permit and execute the lane change assistance control in the circumstance around the host vehicle), the driving assistance ECU 10 does not execute the lane change assistance control (forbids the lane change assistance control) even when a lane change assistance request is generated.

The LCS permission/non-permission determination is performed as follows. That is, when an object being present in the proximity of the host vehicle has a high speed with respect to the host vehicle (that is, a relative speed), the driving assistance ECU 10 performs the determination for the high relative speed object as the LCS permission/non-permission determination. The determination for the high relative speed object uses at least the relative speed of the object. When an object being present in the proximity of the host vehicle has a low relative speed, the driving assistance ECU 10 performs the determination for the low relative speed object as the LCS permission/non-permission determination. The determination for the low relative speed object uses the position of the object (a relative position specified by a distance and an azimuth) and does not use the relative speed of the object due to low accuracy.

Specific Operation

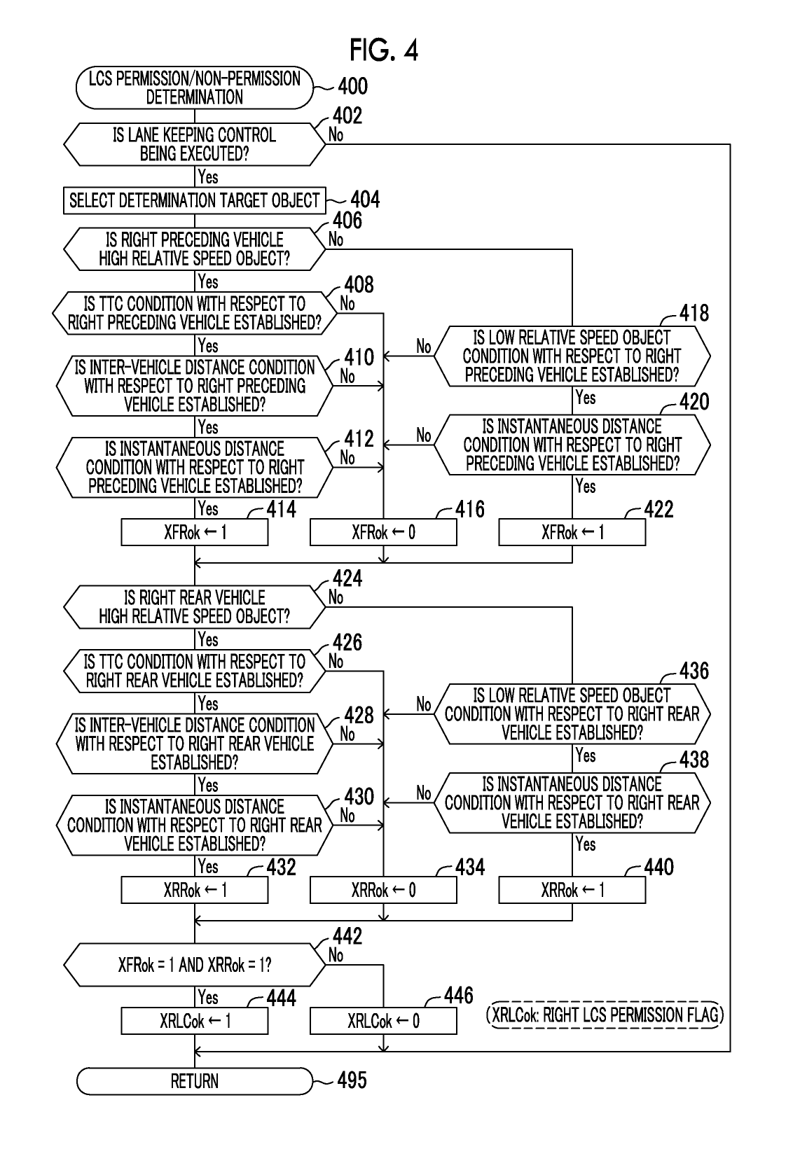

The CPU of the driving assistance ECU 10 (hereinafter, the “CPU” refers to the “CPU of the driving assistance ECU 10” unless otherwise specified) executes an “LCS permission/non-permission determination routine for changing the lane to the right lane” illustrated by a flowchart in FIG. 4 for each elapse of a predetermined time period.

Accordingly, when a predetermined timing arrives, the CPU starts processing from step 400 in FIG. 4 and transitions to step 402 to determine whether or not the lane keeping control is currently being executed. When the lane keeping control is currently not being executed, the CPU makes a “No” determination in step 402 and directly transitions to step 495 to temporarily finish the present routine.

When the lane keeping control is currently being executed, the CPU makes a “Yes” determination in step 402 and transitions to step 404 to select a determination target object.

More specifically, as illustrated in FIG. 5, the CPU selects, from each of the six regions (that is, an FR region, an RR region, an FC region, an RC region, an FL region, and an RL region) divided from a region around the host vehicle SV, an object having the shortest distance (the magnitude of the distance) with the host vehicle SV in the X axis direction of the host vehicle SV as the determination target object in each region. The six regions are as follows.

FR region (front right region): a region that is within a lane adjacent to the host lane on the right side of the host lane (hereinafter, referred to as a “right lane”) and that has an X axis coordinate greater than or equal to “0” and less than or equal to a “predetermined length Da1”.

RR region (rear right region): a region that is within the right lane and that has an X axis coordinate greater than or equal to “−Da1” and less than “0”.

FC region (front center region): a region that is within the host lane and that has an X axis coordinate greater than or equal to “0” and less than or equal to “Da1”.

RC region (rear center region): a region that is within the host lane and that has an X axis coordinate greater than or equal to “−Da1” and less than “0”.

FL region (front left region): a region that is within a lane adjacent to the host lane on the left side of the host lane (hereinafter, referred to as a “left lane”) and that has an X axis coordinate greater than or equal to “0” and less than or equal to “Da1”.

RL region (rear left region): a region that is within the left lane and that has an X axis coordinate greater than or equal to “−Da1” and less than “0”.

In the example illustrated in FIG. 5, another vehicle TV1 that is an object, and another vehicle TV2 that is an object are present in the FR region. The distance to the other vehicle TV1 in the X axis direction is shorter than the distance to the other vehicle TV2 in the X axis direction. Accordingly, the other vehicle TV1 is selected as the determination target object in the FR region. In the example illustrated in FIG. 5, another vehicle TV7 that is an object, and another vehicle TV8 that is an object are present in the RR region. The distance to the other vehicle TV7 in the X axis direction is shorter than the distance to the other vehicle TV8 in the X axis direction. Accordingly, the other vehicle TV7 is selected as the determination target object in the RR region. Similarly, in the example illustrated in FIG. 5, “other vehicles TV3, TVS, TV9, TV11” that are hatched in each region are respectively selected as the determination target objects in the FC region, the FL region, the RC region, and the RL region.

Next, the CPU transitions to step 406 and below in FIG. 4 to determine whether or not a lane change permission condition is established for the determination target object in the FR region (hereinafter, referred to as a “right preceding vehicle”).

More specifically, the CPU determines whether or not the right preceding vehicle is the high relative speed object in step 406. That is, the CPU determines whether or not the magnitude |VrFR| of a relative speed (the speed of the right preceding vehicle with respect to the vehicle speed of the host vehicle in the X axis direction) VrFR of the right preceding vehicle is greater than a predetermined threshold relative speed Vrth (for example, 1.5 [km/h]).

When the magnitude |VrFR| of the relative speed of the right preceding vehicle is greater than the predetermined threshold relative speed Vrth, the right preceding vehicle is the “high relative speed object (that is, an object having a high relative speed)”. Accordingly, in such a case, the CPU makes a “Yes” determination in step 406 and transitions to step 408 to determine whether or not a time-to-collision (TTC) condition described below is established for the right preceding vehicle.

That is, the CPU in step 408 first calculates the absolute value of a value acquired by dividing a distance (inter-vehicle distance) DrFR between the right preceding vehicle and the host vehicle in the X axis direction by the relative speed VrFR of the right preceding vehicle (=right preceding vehicle ground speed−host vehicle ground speed) as a “time-to-collision TTC(FR) with respect to the right preceding vehicle” (TTC(FR)=|DrFR/VrFR|). That is, the time-to-collision TTC(FR) is a time period before collision of the host vehicle with the right preceding vehicle when the host vehicle travels immediately behind the right preceding vehicle while maintaining the current vehicle speed. Next, the CPU determines whether or not the TTC condition with respect to the right preceding vehicle is established by determining whether or not the time-to-collision TTC(FR) is longer than or equal to a threshold time period TTCth. When the relative speed VrFR has a positive value (that is, when the right preceding vehicle is moving away from the host vehicle), the time-to-collision TTC(FR) is set to a value that is sufficiently greater than the threshold time period TTCth. Accordingly, when the right preceding vehicle is moving away from the host vehicle, the TTC condition with respect to the right preceding vehicle is always established.

When the time-to-collision TTC(FR) is assumed to be longer than or equal to the threshold time period TTCth, the TTC condition with respect to the right preceding vehicle is established. Thus, the CPU makes a “Yes” determination in step 408 and transitions to step 410.

The CPU in step 410 determines whether or not an inter-vehicle distance condition with respect to the right preceding vehicle is established. The determination as to whether or not the inter-vehicle distance condition is established is performed in the following three cases. When at least one inter-vehicle distance condition set for any of the cases is established, the CPU determines that the inter-vehicle distance condition with respect to the right preceding vehicle is established.

Case A

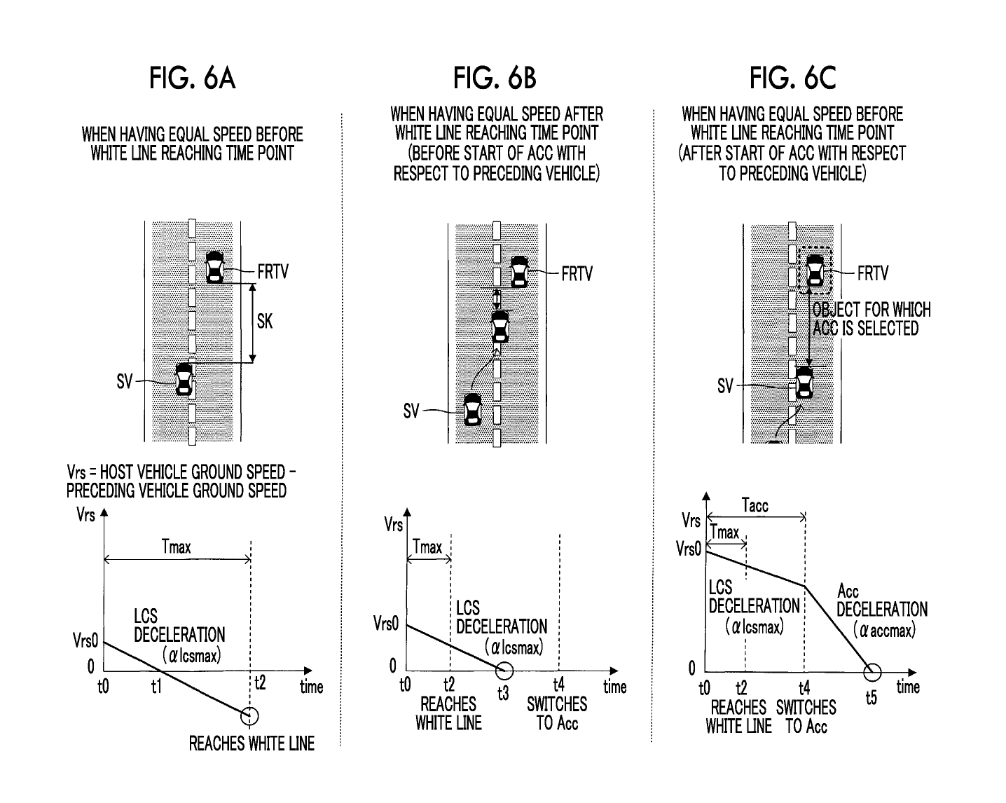

As illustrated in FIG. 6A, a case A is a case in which the relative speed of a right preceding vehicle FRTV becomes “0” at time point tl before white line reaching time point t2 (that is, the host vehicle SV has an equal speed to the right preceding vehicle FRTV) when it is assumed that the host vehicle SV starts to change the lane by the lane change assistance control at time point t0 (that is, starts to change the lateral position toward the right lane) and decelerates at a maximum deceleration alcsmax (for example, 0.07 G) allowed in the lane change assistance control. The white line reaching time is a time point at which a right end portion of the host vehicle SV reaches a white line (dividing line) that divides the host lane and the right lane. A relative speed Vrs in such a case is a value acquired by subtracting the ground speed of the preceding vehicle FRTV from the ground speed of the host vehicle SV (Vrs=host vehicle ground speed−preceding vehicle ground speed). Thus, when the relative speed Vrs is positive, the host vehicle SV approaches the right preceding vehicle FRTV. When the relative speed Vrs is negative, the host vehicle SV moves away from the right preceding vehicle FRTV.

In such a case, both of the host vehicle SV and the right preceding vehicle FRTV are unlikely to come into contact with each other before the host vehicle SV reaches the white line, even with any inter-vehicle distance between the host vehicle SV and the right preceding vehicle FRTV. The host vehicle SV may be assumed to be capable of continuing deceleration at the maximum deceleration alcsmax even after reaching the white line. Accordingly, when an inter-vehicle distance SK between the host vehicle SV and the preceding vehicle FRTV is longer than or equal to a threshold inter-vehicle distance SKth at white line reaching time point t2, a sufficiently long inter-vehicle distance between the host vehicle SV and the right preceding vehicle FRTV is achieved even after white line reaching time point t2 (that is, after a time point at which the host vehicle SV starts entering the right lane). The threshold inter-vehicle distance SKth is set to a distance (for example, 10 m) that enables the host vehicle SV to safely change the lane without excessively approaching the right preceding vehicle FRTV. A maximum value Tmax of a time period to white line reaching time point t2 from time point tO at which the host vehicle SV starts to change the lane by the lane change assistance control can be determined in advance from the general road width and the lateral speed (the speed of movement in the Y axis direction) of the host vehicle in the lane change assistance control (in the present example, the maximum value Tmax of the time period is set to two seconds).

Accordingly, the CPU acquires a time period te through which the relative speed Vrs with respect to the right preceding vehicle FRTV becomes “0” (te=Vrs0/αlcsmax; Vrs0 is the relative speed Vrs at time point tO of the start of the lane change assistance control). When the time period te is shorter than or equal to the “preset maximum value Tmax of the time period from time point tO to white line reaching time point t2”, the CPU determines that the case A is established. When the CPU determines that the case A is established, the CPU estimates an inter-vehicle distance SKt2 with respect to the right preceding vehicle FRTV at white line reaching time point t2 by simple calculation (refer to the following general formula). When the inter-vehicle distance SKt2 is longer than or equal to the threshold inter-vehicle distance SKth, the CPU determines that the inter-vehicle distance condition set for the case A is established.

Inter-vehicle distance SKt2=SK0−Vrs0·Tmax+(½)·αlcsmax·Tmax² (SK0: the inter-vehicle distance between the host vehicle and the right preceding vehicle at time point t0 of the start of the lane change assistance control)

The inter-vehicle distance SKt2 may also be acquired by applying the actual relative speed Vrs0 and an actual inter-vehicle distance SK0 to a lookup table MapSKt2(Vrs0, SK0).

Case B

As illustrated in FIG. 6B, a case B is a case in which the relative speed Vrs of the right preceding vehicle FRTV becomes “0” at time point t3 that is after white line reaching time point t2 and before time point t4 of the start of the inter-vehicle following distance control (ACC) having the right preceding vehicle FRTV as the following target vehicle, when it is assumed that the host vehicle SV starts to change the lane by the lane change assistance control at time point tO and decelerates at the maximum deceleration alcsmax.

In such a case, the host vehicle approaches the right preceding vehicle even after a time point at which the host vehicle SV reaches the white line and enters the right lane. The inter-vehicle distance SK between the host vehicle and the right preceding vehicle has the minimum value at time point t3. Thus, when the inter-vehicle distance SK at time point t3 is longer than or equal to the threshold inter-vehicle distance SKth, the host vehicle is considered to be capable of safely changing the lane.

Accordingly, the CPU acquires the time period te from time point tO to time point t3 (te=Vrs0/αlcsmax). When the time period te is longer than the “preset maximum value Tmax of the time period from time point tO to white line reaching time point t2” and shorter than a time period Tacc described below, the CPU acquires an inter-vehicle distance SKt3 at time point t3 by using the time period te (refer to the following general formula). When the inter-vehicle distance SKt3 is longer than or equal to the threshold inter-vehicle distance SKth, the CPU determines that the inter-vehicle distance condition set for the case B is established. The inter-vehicle distance SKt3 may also be acquired by applying the actual relative speed Vrs0 and the actual inter-vehicle distance SK0 to a lookup table MapSKt3(Vrs0, SK0).

Inter-vehicle distance SKt3=SK0−Vrs0·te+(½)·αlcsmax·te²

Case C

After the host vehicle SV changes the lane, the host vehicle SV resumes the inter-vehicle following distance control with respect to the right preceding vehicle FRTV (at the time point of resuming the inter-vehicle following distance control, the right preceding vehicle FRTV is a preceding vehicle traveling immediately ahead of the host vehicle SV). A maximum deceleration aaccmax (0.15 G in the present example) allowed in the inter-vehicle following distance control is greater than the maximum deceleration alcsmax in the lane change assistance control.

Accordingly, as illustrated in FIG. 6C, when the host vehicle SV decelerates from time point tO at the maximum deceleration alcsmax, and the relative speed Vrs has a positive value at time point t4 after elapse of a predetermined time period from time point t0 (that is, when the host vehicle SV is still approaching the right preceding vehicle FRTV), the host vehicle SV can decelerate at the maximum deceleration aaccmax by the inter-vehicle following distance control that is started after time point t4 with the right preceding vehicle FRTV as the following target vehicle. A maximum value Tacc of a time period from time point t0 of the start of the lane change assistance control to a time point of the start of the inter-vehicle following distance control with respect to the right preceding vehicle can be determined in advance from the general road width and the lateral speed of the host vehicle in the lane change assistance control (in the present example, the maximum value Tacc of the time period is set to six seconds).

Accordingly, the CPU acquires the time period te through which the relative speed Vrs with respect to the right preceding vehicle FRTV becomes “0” (te=Vrs0/αlcsmax). When the time period te is longer than the “maximum value Tacc of the time period before the start of the inter-vehicle following distance control with respect to the right preceding vehicle FRTV”, the CPU acquires time point t5 at which the relative speed Vrs with respect to the right preceding vehicle FRTV becomes “0”, on the assumption that the host vehicle decelerates at the maximum deceleration alcsmax in the time period Tacc from time point t0 to time point t4 and decelerates at the maximum deceleration aaccmax after time point t4. The CPU estimates an inter-vehicle distance SKt5 with respect to the right preceding vehicle at time point t5 by simple calculation based on the same idea as above. When the inter-vehicle distance SKt5 is longer than or equal to the threshold inter-vehicle distance SKth, the CPU determines that the inter-vehicle distance condition set for a case C is established. The inter-vehicle distance SKt5 may also be acquired by applying the actual relative speed Vrs0 and the actual inter-vehicle distance SK0 to a lookup table MapSKt5(Vrs0, SK0).

Now, it is assumed that at least one of the inter-vehicle distance conditions set for the three cases (that is, the case A, the case B, and the case C) is established. That is, it is assumed that the inter-vehicle distance condition with respect to the right preceding vehicle is established. In such a case, the CPU makes a “Yes” determination in step 410 of the routine in FIG. 4 and transitions to step 412 to determine whether or not an instantaneous distance condition with respect to the right preceding vehicle is established.

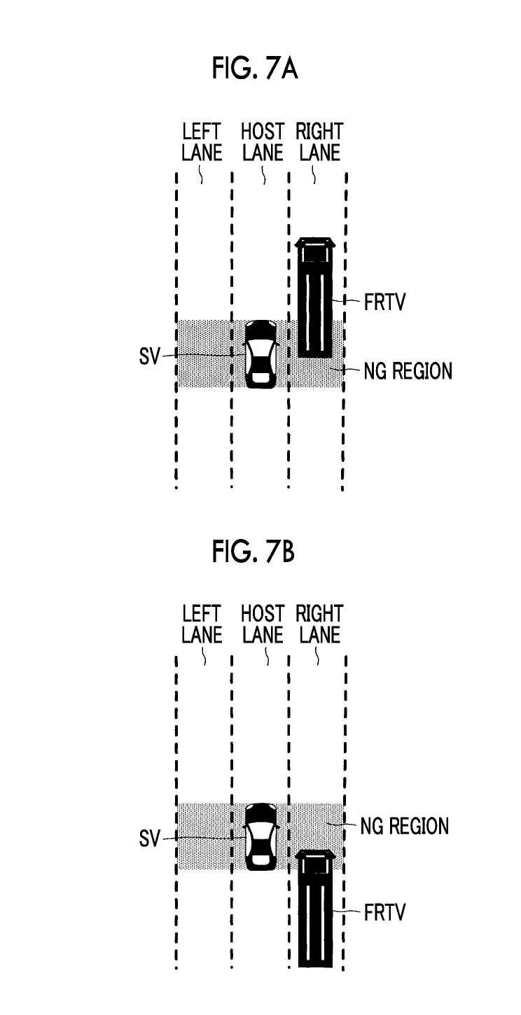

The instantaneous distance condition is a condition that is established when the right preceding vehicle FRTV is not present on the laterally right side of the host vehicle SV. For example, in a circumstance illustrated in FIG. 7A, the right preceding vehicle FRTV is present on the laterally right side of the host vehicle SV. Thus, the instantaneous distance condition is not established. More specifically, when the right preceding vehicle FRTV is not present in a region that is within the right lane and has a longitudinal direction from the front end portion to a rear end portion of the host vehicle SV (hereinafter, referred to as a “laterally right region” or “NG region”), the CPU determines that the instantaneous distance condition with respect to the right preceding vehicle is established.

Now, it is assumed that the instantaneous distance condition with respect to the right preceding vehicle is established. In such a case, the CPU makes a “Yes” determination in step 412 illustrated in FIG. 4 and transitions to step 414 to set the value of a lane change permission flag XFRok to “1” for the right preceding vehicle.

As described heretofore, when the right preceding vehicle is the high relative speed object, the CPU sets the value of the lane change permission flag XFRok to “1” for the right preceding vehicle when all conditions below are established.

(a) The TTC condition with respect to the right preceding vehicle is established (refer to step 408).

(b) The inter-vehicle distance condition with respect to the right preceding vehicle is established (refer to step 410).

(c) The instantaneous distance condition with respect to the right preceding vehicle is established (refer to step 412).

The determination as to whether or not the conditions (a), (b) are established uses the relative speed of the right preceding vehicle as described above. The conditions (a) to (c) or the conditions (a), (b) may be referred to as a “first execution permission condition” for convenience.

When the TTC condition with respect to the right preceding vehicle is not established, the CPU makes a “No” determination in step 408 and transitions to step 416 to set the value of the lane change permission flag XFRok to “0” for the right preceding vehicle. Similarly, when the inter-vehicle distance condition with respect to the right preceding vehicle is not established, the CPU makes a “No” determination in step 410 and transitions to step 416 to set the value of the lane change permission flag XFRok to “0” for the right preceding vehicle. Similarly, when the instantaneous distance condition with respect to the right preceding vehicle is not established, the CPU makes a “No” determination in step 412 and transitions to step 416 to set the value of the lane change permission flag XFRok to “0” for the right preceding vehicle.

When the determination target object in the FR region (that is, the right preceding vehicle) is not the high relative speed object at the time point of the CPU executing the process of step 406, the CPU makes a “No” determination in step 406 and transitions to step 418 to determine whether or not a low relative speed object condition with respect to the right preceding vehicle is established.

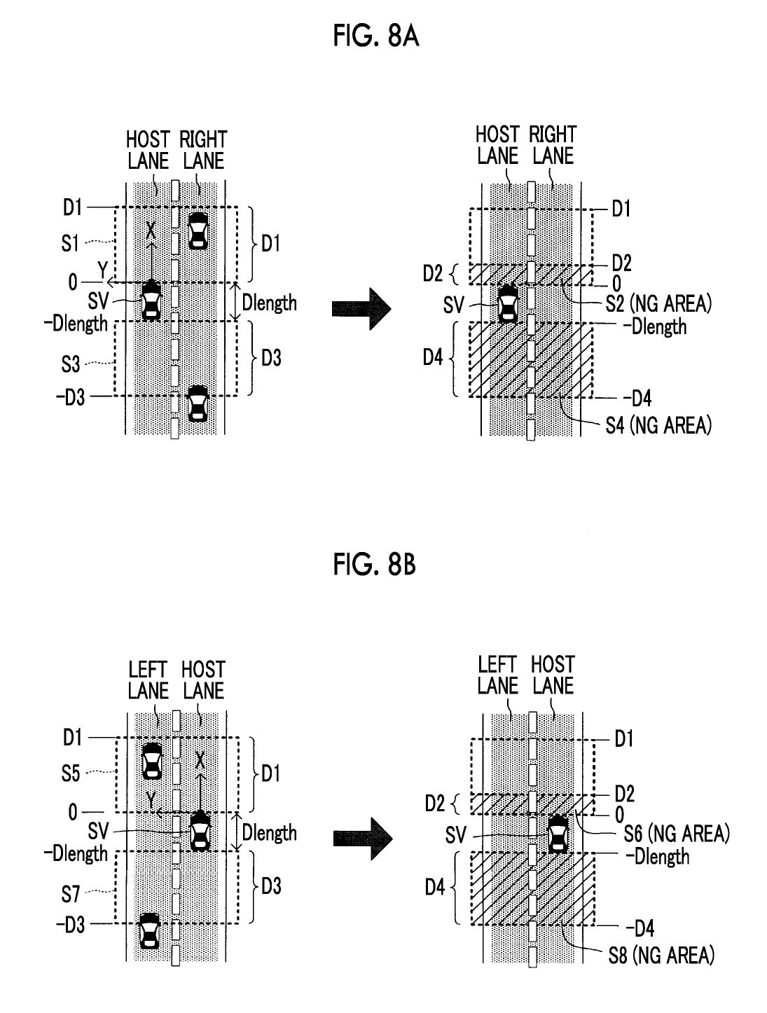

More specifically, as illustrated in the left diagram of FIG. 8A, the CPU extracts all objects (other vehicles) that are present within a region S1 which is a region within the host lane and the right lane and has an X axis coordinate greater than or equal to “0” and less than or equal to a “front distance D1 of a predetermined length (for example, 10 [m])”. As illustrated in the right diagram of FIG. 8A, the CPU determines whether or not at least one of the extracted objects is present within a region S2 that is a region within the host lane and the right lane and has an X axis coordinate greater than or equal to “0” and less than or equal to a “length D2 shorter than or equal to D1 (for example, 2 [m]). The CPU may divide the region S2 into a region S2a within the host lane and a region S2b within the right lane and determine whether or not an object is present in each region. The CPU may employ, as the low relative speed object condition with respect to the right preceding vehicle, a condition that an object is not present within the region S2b.

When an object is not present in the region S2, the low relative speed object condition with respect to the right preceding vehicle is established. In such a case, the CPU makes a “Yes” determination in step 418 of the routine in FIG. 4 and transitions to step 420 to determine whether or not the instantaneous distance condition with respect to the right preceding vehicle is established. The process of step 420 is the same as the process of step 412. That is, the CPU determines whether or not the right preceding vehicle FRTV is not present on the laterally right side of the host vehicle SV.

When the right preceding vehicle FRTV is not present on the laterally right side of the host vehicle SV, the CPU makes a “Yes” determination in step 420 and transitions to step 422 to set the value of the lane change permission flag XFRok to “1” for the right preceding vehicle.

As described heretofore, when the right preceding vehicle is the low relative speed object, the CPU sets the value of the lane change permission flag XFRok to “1” for the right preceding vehicle when all conditions below are established.

(d) The low relative speed object condition with respect to the right preceding vehicle is established (refer to step 418).

(e) The instantaneous distance condition with respect to the right preceding vehicle is established (refer to step 420).

The determination as to whether or not the conditions (d), (e) are established does not use the relative speed of the right preceding vehicle and uses the distance (a position determined from a distance and an azimuth) of the right preceding vehicle with respect to the host vehicle. The conditions (d), (e) or the condition (a) may be referred to as a “second execution permission condition” for convenience.

When the low relative speed object condition with respect to the right preceding vehicle is not established, the CPU makes a “No” determination in step 418 and transitions to step 416 to set the value of the lane change permission flag XFRok to “0” for the right preceding vehicle. Similarly, when the instantaneous distance condition with respect to the right preceding vehicle is not established, the CPU makes a “No” determination in step 420 and transitions to step 416 to set the value of the lane change permission flag XFRok to “0” for the right preceding vehicle.

When the CPU finishes the process of any of step 414, step 416, and step 422, the CPU transitions to step 424 and below to determine whether or not the lane change permission condition is established for the determination target object in the RR region (hereinafter, referred to as a “right rear vehicle”).

More specifically, the CPU determines whether or not the right rear vehicle is the high relative speed object in step 424. That is, the CPU determines whether or not the magnitude |VrRR| of a relative speed (the speed of the object with respect to the vehicle speed of the host vehicle in the X axis direction) VrRR of the right rear vehicle is greater than the predetermined threshold relative speed Vrth.

When the magnitude |VrRR| of the relative speed of the right rear vehicle is greater than the predetermined threshold relative speed Vrth, the right rear vehicle is the “high relative speed object”. Accordingly, in such a case, the CPU makes a “Yes” determination in step 424 and transitions to step 426 to determine whether or not a TTC condition described below is established for the right rear vehicle.

More specifically, the CPU in step 426 first calculates the absolute value of a value acquired by dividing a distance DrRR between the right rear vehicle and the host vehicle (that is, a distance DrRR between the rear end portion of the host vehicle and a front end portion of the right rear vehicle) by the relative speed VrRR of the right rear vehicle (=right rear vehicle ground speed−host vehicle ground speed) as a “time-to-collision TTC(RR) with respect to the right rear vehicle” (TTC(RR)=IDrRR/VrRRI). That is, the time-to-collision TTC(RR) is a time period before collision of the right rear vehicle with the host vehicle when the host vehicle travels immediately ahead of the right rear vehicle while the host vehicle and the right rear vehicle maintain the current vehicle speed. The distance DrRR is calculated by subtracting a length (vehicle length) Dlength between the front end portion and the rear end portion of the host vehicle from the absolute value of the distance of the right rear vehicle. Next, the CPU determines whether or not the TTC condition with respect to the right rear vehicle is established by determining whether or not the time-to-collision TTC(RR) is longer than or equal to the threshold time period TTCth. When the relative speed VrRR has a negative value (that is, when the host vehicle is moving away from the right rear vehicle), the time-to-collision TTC(RR) is set to a value that is sufficiently greater than the threshold time period TTCth. Accordingly, when the host vehicle is moving away from the right rear vehicle, the TTC condition with respect to the right rear vehicle is always established.

When the time-to-collision TTC(RR) is assumed to be longer than or equal to the threshold time period TTCth, the TTC condition with respect to the right rear vehicle is established. Thus, the CPU makes a “Yes” determination in step 426 and transitions to step 428.

The CPU in step 428 determines whether or not an inter-vehicle distance condition with respect to the right rear vehicle is established. The determination as to whether or not the inter-vehicle distance condition is established is performed in the following two cases. When at least one inter-vehicle distance condition set for any of the cases is established, the CPU determines that the inter-vehicle distance condition with respect to the right rear vehicle is established.

Case D

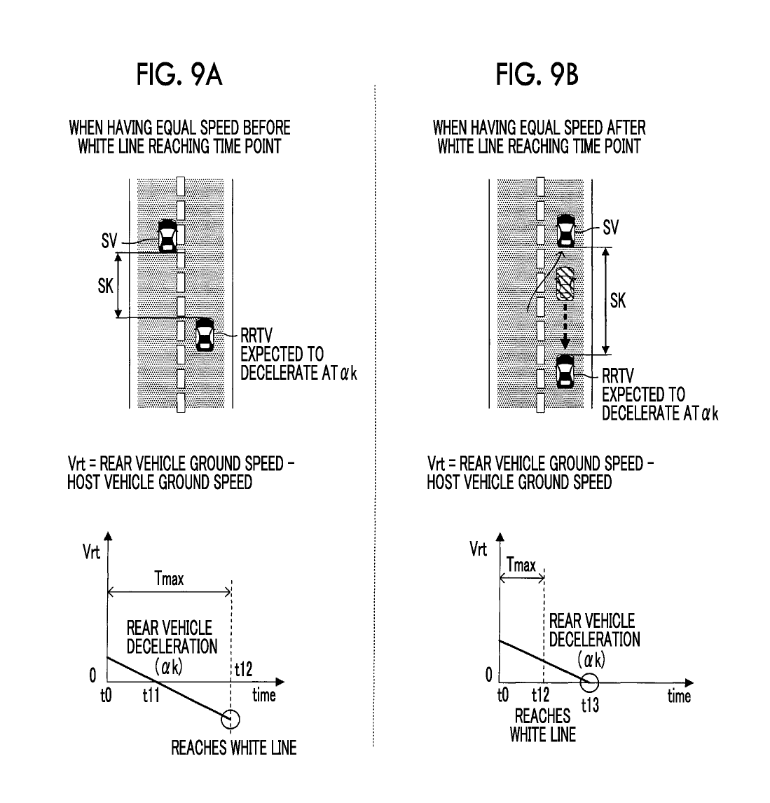

As illustrated in FIG. 9A, a case D is a case in which a relative speed Vrt with respect to a right rear vehicle RRTV becomes “0” at time point tll before white line reaching time point t12 when it is assumed that the host vehicle SV starts to change the lane by the lane change assistance control at time point t0 (that is, starts to change the lateral position toward the right lane) and that the right rear vehicle RRTV decelerates at a predetermined deceleration ak due to the lane change assistance control. When the lane change assistance control is started, the blinker is caused to blink. Thus, the right rear vehicle RRTV can be expected to decelerate at the deceleration ak that is not in a range of rapid deceleration (for example, a deceleration due to engine braking by releasing the accelerator pedal; 0.07 G in the present example). Accordingly, the right rear vehicle RRTV is assumed to decelerate at the deceleration αk. When the relative speed Vrt with respect to the right rear vehicle RRTV becomes “0”, the host vehicle SV has an equal speed to the right rear vehicle RRTV, and the right rear vehicle RRTV is at the closest point to the host vehicle SV. The relative speed Vrt in such a case is a value acquired by subtracting the ground speed of the host vehicle SV from the ground speed of the right rear vehicle RRTV (Vrt=rear vehicle ground speed−host vehicle ground speed). Thus, when the relative speed Vrt is positive, the right rear vehicle RRTV approaches the host vehicle SV. When the relative speed Vrt is negative, the right rear vehicle RRTV moves away from the host vehicle SV.

In such a case, both of the host vehicle SV and the right rear vehicle RRTV are unlikely to come into contact with each other before the host vehicle SV reaches the white line (the white line on the right side of the host lane), even with any inter-vehicle distance between the host vehicle SV and the right rear vehicle RRTV. The right rear vehicle RRTV is considered to continue decelerating at the deceleration ak even after the host vehicle SV reaches the white line. Thus, when the inter-vehicle distance SK between the host vehicle SV and the right rear vehicle RRTV is longer than or equal to the threshold inter-vehicle distance SKth at white line reaching time point t12, a sufficiently long distance between the host vehicle SV and the right rear vehicle RRTV is achieved even after white line reaching time point t12 (that is, after a time point at which the host vehicle starts entering the right lane). The maximum value Tmax of a time period to white line reaching time point t12 from time point tO at which the host vehicle SV starts to change the lane by the lane change assistance control can be determined in advance as described above.

Accordingly, the CPU acquires a time period tf through which the relative speed Vrt with respect to the right rear vehicle RRTV becomes “0” (tf=Vrt0/αk; Vrt0 is the relative speed Vrt at time point t0 of the start of the lane change assistance control). When the time period tf is shorter than or equal to the “preset maximum value Tmax of the time period from time point t0 to white line reaching time point t12”, the CPU determines that the case D is established. When the CPU determines that the case D is established, the CPU estimates an inter-vehicle distance SKt12 with respect to the right rear vehicle at white line reaching time point t12 by simple calculation as in the case A. When the inter-vehicle distance SKt12 is longer than or equal to the threshold inter-vehicle distance SKth, the CPU determines that the inter-vehicle distance condition set for the case D is established. The inter-vehicle distance SKt12 may also be acquired by applying the actual relative speed Vrt0 and an actual inter-vehicle distance SK1 (the inter-vehicle distance between the host vehicle and the right rear vehicle at time point t0 of the start of the lane change assistance control) to a lookup table MapSKt12(Vrt0, SK1).

Case E

As illustrated in FIG. 9B, a case E is a case in which the relative speed Vrt of the right rear vehicle becomes “0” at time point t13 after white line reaching time point t12 when it is assumed that the host vehicle SV starts to change the lane by the lane change assistance control at time point t0 and that the right rear vehicle decelerates at the predetermined deceleration ak.

In such a case, the right rear vehicle RRTV approaches the host vehicle SV even after a time point at which the host vehicle SV reaches the white line and enters the right lane. The inter-vehicle distance SK between the host vehicle SV and the right rear vehicle RRTV has the minimum value at time point t13. Thus, when the inter-vehicle distance SK at time point t13 is longer than or equal to the threshold inter-vehicle distance SKth and is sufficiently long, the host vehicle SV is considered to be capable of changing the lane with a sufficient amount of time.

Accordingly, the CPU acquires the time period tf from time point tO to time point t13 (tf=Vrt0/ak). When the time period tf is longer than the “preset maximum value Tmax of the time period from time point t0 to white line reaching time point t12”, the CPU estimates an inter-vehicle distance SKt13 at time point t13 by simple calculation as in the case B using the time period tf. When the inter-vehicle distance SKt13 is longer than or equal to the threshold inter-vehicle distance SKth, the CPU determines that the inter-vehicle distance condition set for the case E is established. The inter-vehicle distance SKt13 may also be acquired by applying the actual relative speed Vrt0 and the actual inter-vehicle distance SK1 to a lookup table MapSKt13(Vrt0, SK1).

Now, it is assumed that at least one of the inter-vehicle distance conditions set for the two cases (that is, the case D and the case E) is established. That is, it is assumed that the inter-vehicle distance condition with respect to the right rear vehicle is established. In such a case, the CPU makes a “Yes” determination in step 428 of the routine in FIG. 4 and transitions to step 430 to determine whether or not an instantaneous distance condition with respect to the right rear vehicle is established.

The instantaneous distance condition is a condition that is established when the right rear vehicle RRTV is not present on the laterally right side of the host vehicle SV. For example, in a circumstance illustrated in FIG. 7B, the right rear vehicle RRTV is present on the laterally right side of the host vehicle SV. Thus, the instantaneous distance condition is not established. More specifically, when the right rear vehicle RRTV is not present in the laterally right region (NG region), the CPU determines that the instantaneous distance condition with respect to the right rear vehicle is established.

Now, it is assumed that the instantaneous distance condition with respect to the right rear vehicle is established. In such a case, the CPU makes a “Yes” determination in step 430 and transitions to step 432 to set the value of a lane change permission flag XRRok to “1” for the right rear vehicle.

As described heretofore, when the right rear vehicle is the high relative speed object, the CPU sets the value of the lane change permission flag XRRok to “1” for the right rear vehicle when all conditions below are established.

(f) The TTC condition with respect to the right rear vehicle is established (refer to step 426).

(g) The inter-vehicle distance condition with respect to the right rear vehicle is established (refer to step 428).

(h) The instantaneous distance condition with respect to the right rear vehicle is established (refer to step 430).

The determination as to whether or not the conditions (f), (g) are established uses the relative speed of the right rear vehicle as described above. The conditions (f) to (h) or the conditions (f), (g) may be referred to as the “first execution permission condition” for convenience.

When the TTC condition with respect to the right rear vehicle is not established, the CPU makes a “No” determination in step 426 and transitions to step 434 to set the value of the lane change permission flag XRRok to “0” for the right rear vehicle. Similarly, when the inter-vehicle distance condition with respect to the right rear vehicle is not established, the CPU makes a “No” determination in step 428 and transitions to step 434 to set the value of the lane change permission flag XRRok to “0” for the right rear vehicle. Similarly, when the instantaneous distance condition with respect to the right rear vehicle is not established, the CPU makes a “No” determination in step 430 and transitions to step 434 to set the value of the lane change permission flag XRRok to “0” for the right rear vehicle.

When the determination target object in the RR region (that is, the right rear vehicle) is not the high relative speed object at the time point of the CPU executing the process of step 424, the CPU makes a “No” determination in step 424 and transitions to step 436 to determine whether or not a low relative speed object condition with respect to the right rear vehicle is established.

More specifically, as illustrated in the left diagram of FIG. 8A, the CPU extracts all objects (other vehicles) that are present within a region S3 which is a region within the host lane and the right lane and has an X axis coordinate greater than or equal to a value (−D3) acquired by inverting the sign of a “rear distance D3 of a predetermined length (for example, 10 [m])” and less than or equal to “−Dlength”. Dlength is the length of the host vehicle SV in the front-rear direction as described above. As illustrated in the right diagram of FIG. 8A, the CPU determines whether or not at least one of the extracted objects is present within a region S4 that is a region within the host lane and the right lane and has an X axis coordinate greater than or equal to a value (−D4) acquired by inverting the sign of a “length D4 shorter than or equal to the length D3” and less than or equal to “−Dlength”. The CPU may divide the region S4 into a region S4a within the host lane and a region S4b within the right lane and determine whether or not an object is present in each region. The CPU may employ, as the low relative speed object condition with respect to the right rear vehicle, a condition that an object is not present within the region S4b.

When an object is not present in the region S4, the low relative speed object condition with respect to the right rear vehicle is established. In such a case, the CPU makes a “Yes” determination in step 436 and transitions to step 438 to determine whether or not the instantaneous distance condition with respect to the right rear vehicle is established. The process of step 438 is the same as the process of step 430. That is, the CPU determines whether or not the right rear vehicle RRTV is not present on the laterally right side of the host vehicle SV.

When the right rear vehicle RRTV is not present on the laterally right side of the host vehicle SV, the CPU makes a “Yes” determination in step 438 and transitions to step 440 to set the value of the lane change permission flag XRRok to “1” for the right rear vehicle.

As described heretofore, when the right rear vehicle is the low relative speed object, the CPU sets the value of the lane change permission flag XRRok to “1” for the right rear vehicle when all conditions below are established.

(i) The low relative speed object condition with respect to the right rear vehicle is established (refer to step 436).

(j) The instantaneous distance condition with respect to the right rear vehicle is established (refer to step 438).

The determination as to whether or not the conditions (i), (j) are established does not use the relative speed of the right rear vehicle and uses the distance (a position determined from a distance and an azimuth) of the right rear vehicle with respect to the host vehicle. The conditions (i), (j) or the condition (i) may be referred to as the “second execution permission condition” for convenience.

When the low relative speed object condition with respect to the right rear vehicle is not established, the CPU makes a “No” determination in step 436 and transitions to step 434 to set the value of the lane change permission flag XRRok to “0” for the right rear vehicle. Similarly, when the instantaneous distance condition with respect to the right rear vehicle is not established, the CPU makes a “No” determination in step 438 and transitions to step 434 to set the value of the lane change permission flag XRRok to “0” for the right rear vehicle.

When the CPU finishes the process of any of step 432, step 434, and step 440, the CPU transitions to step 442 to determine whether or not the value of the lane change permission flag XFRok is “1” for the right preceding vehicle and the value of the lane change permission flag XRRok is “1” for the right rear vehicle.

When both of the value of the lane change permission flag XFRok and the value of the lane change permission flag XRRok are “1”, the CPU makes a “Yes” determination in step 442 and transitions to step 444 to set the value of a right lane change control permission flag (right LCS permission flag) XRLCok to “1”. Then, the CPU transitions to step 495 to temporarily finish the present routine.

When at least one of the value of the lane change permission flag XFRok and the value of the lane change permission flag XRRok is “0”, the CPU makes a “No” determination in step 442 and transitions to step 446 to set the value of the right lane change control permission flag XRLCok to “0”. Then, the CPU transitions to step 495 to temporarily finish the present routine.

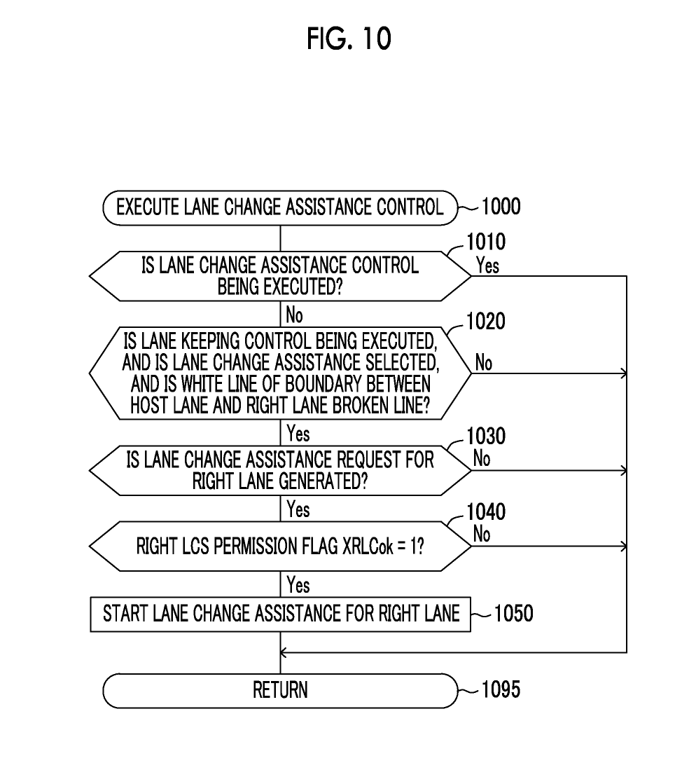

The CPU executes a “lane change assistance control execution routine” illustrated by a flowchart in FIG. 10 for each elapse of a predetermined time period.

Accordingly, when a predetermined timing arrives, the CPU starts processing from step 1000 in FIG. 10 and transitions to step 1010 to determine whether or not the lane change assistance control is currently being executed.

When the lane change assistance control is currently not being executed, the CPU makes a “No” determination in step 1010 and transitions to step 1020 to determine whether or not all of the following three conditions are established.

The lane keeping control is being executed.

The lane change assistance is selected by the operating switch 17.

The white line that is a boundary between the host lane and the right lane is a broken line.

The condition “the lane keeping control is being executed” is established when all of the following conditions are established.

Execution of the lane keeping control is selected by the operating switch 17.

The inter-vehicle following distance control is being executed.

Both of the “left white line and the right white line” of the host lane are recognized.

Now, it is assumed that all of the three conditions are established. In such a case, the CPU makes a “Yes” determination in step 1020 and transitions to step 1030 to determine whether or not a lane change assistance request for the right lane is generated by operating the blinker lever.

When a lane change assistance request for the right lane is generated, the CPU makes a “Yes” determination in step 1030 and transitions to step 1040 to determine whether or not the value of the right lane change control permission flag XRLCok is set to “1”.

When the value of the right lane change control permission flag XRLCok is set to “1”, the CPU makes a “Yes” determination in step 1040 and transitions to step 1050 to start executing the lane change assistance control for the right lane. Then, the CPU recognizes that the lane change assistance control is being executed, before the time point at which the CPU determines that changing the lane to the right lane is finished. Then, the CPU transitions to step 1095 to temporarily finish the present routine.

When the lane change assistance control is currently being executed, the CPU makes a “Yes” determination in step 1010 and directly transitions to step 1095 to temporarily finish the present routine. When at least one of the three conditions determined in step 1020 is currently not established, the CPU makes a “No” determination in step 1020 and directly transitions to step 1095 to temporarily finish the present routine. When a lane change assistance request for the right lane is currently not generated, the CPU makes a “No” determination in step 1030 and directly transitions to step 1095 to temporarily finish the present routine. When the value of the right lane change control permission flag XRLCok is set to “0”, the CPU makes a “No” determination in step 1040 and directly transitions to step 1095 to temporarily finish the present routine. Accordingly, when the value of the right lane change control permission flag XRLCok is “0”, the lane change assistance control is forbidden.

As described heretofore, the CPU executes the “LCS permission/non-permission determination for changing the lane to the right lane”. The CPU forbids or permits the lane change control in accordance with the determination result.

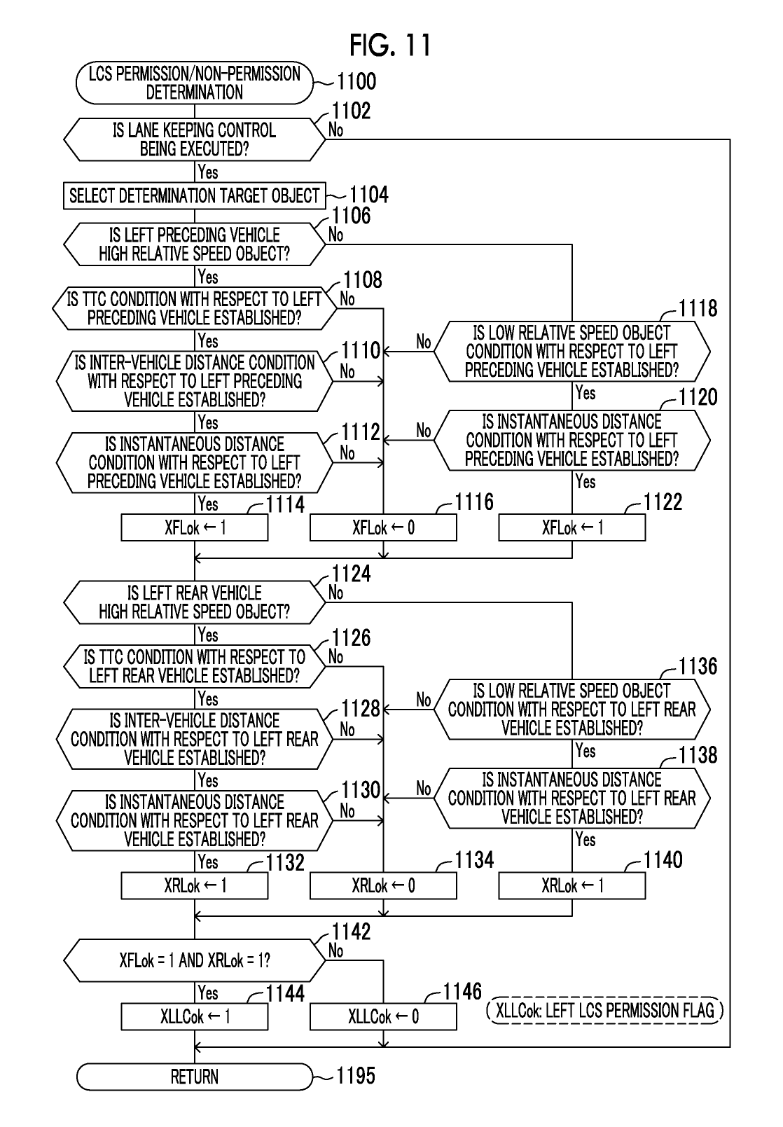

The CPU executes an “LCS permission/non-permission determination routine for changing the lane to the left lane” illustrated by a flowchart in FIG. 11 for each elapse of a predetermined time period. The routine is different from the routine illustrated in FIG. 4 in that the determination target object is a “preceding vehicle and a rear vehicle in the left lane”. Accordingly, hereinafter, the routine in FIG. 11 will be briefly described with focus on the difference from FIG. 4.

Step 1102: a step in which the same process as step 402 is performed.

Step 1104: a step in which the same process as step 404 is performed.

Step 1106: The CPU determines whether or not a left preceding vehicle (the determination target object in the FL region) is the high relative speed object. That is, the CPU determines whether or not the magnitude |VrFL| of a relative speed VrFL of the left preceding vehicle is greater than a predetermined threshold relative speed Vrth. When the left preceding vehicle is the high relative speed object, the CPU transitions to step 1108.

Step 1108: The CPU first calculates the absolute value of a value acquired by dividing a distance (inter-vehicle distance) DrFL between the left preceding vehicle and the host vehicle by the relative speed VrFL of the left preceding vehicle (=left preceding vehicle ground speed−host vehicle ground speed) as a “time-to-collision TTC(FL) with respect to the left preceding vehicle”. Next, the CPU determines whether or not a TTC condition with respect to the left preceding vehicle is established by determining whether or not the time-to-collision TTC(FL) is longer than or equal to the threshold time period TTCth. When the relative speed VrFL has a positive value, the time-to-collision TTC(FL) is set to a value that is sufficiently greater than the threshold time period TTCth.

Step 1110: When the TTC condition with respect to the left preceding vehicle is established, the CPU transitions to step 1110. The CPU calculates the inter-vehicle distance between the host vehicle and the left preceding vehicle having an equal speed in each case in the same manner as “the case A, the case B, and the case C”. When the calculated inter-vehicle distance is longer than or equal to the threshold inter-vehicle distance SKth, the CPU determines that the inter-vehicle distance condition is established, and transitions to step 1112.

Step 1112: The CPU determines whether or not an instantaneous distance condition with respect to the left preceding vehicle is established. The instantaneous distance condition is a condition that is established when the left preceding vehicle is not present on the laterally left side of the host vehicle. When the instantaneous distance condition with respect to the left preceding vehicle is established, the CPU transitions to step 1114.

Step 1114: The CPU sets the value of a lane change permission flag XFLok to “1” for the left preceding vehicle.

Step 1116: When the CPU makes a “No” determination in any of step 1108 to step 1112, the CPU transitions to step 1116 to set the value of the lane change permission flag XFLok to “0” for the left preceding vehicle.

Step 1118: When the CPU in step 1106 determines that the left preceding vehicle is not the high relative speed object (that is, the low relative speed object), the CPU transitions to step 1118 from step 1106 to determine whether or not a low relative speed object condition with respect to the left preceding vehicle is established.

More specifically, as illustrated in the left diagram of FIG. 8B, the CPU extracts all objects (other vehicles) that are present within a region S5 which is a region within the host lane and the left lane and has an X axis coordinate greater than or equal to “0” and less than or equal to the “length D1”. As illustrated in the right diagram of FIG. 8B, the CPU determines whether or not at least one of the extracted objects is present within a region S6 that is a region within the host lane and the left lane and has an X axis coordinate greater than or equal to “0” and less than or equal to the length D2″. When an object is not present in the region S6, the low relative speed object condition with respect to the left preceding vehicle is established.

Step 1120: When the low relative speed object condition with respect to the left preceding vehicle is established, the CPU transitions to step 1120 to determine whether or not an instantaneous distance condition with respect to the left preceding vehicle is established. The process of step 1120 is the same as the process of step 1112.

Step 1122: When the instantaneous distance condition with respect to the left preceding vehicle is established, the CPU transitions to step 1122 to set the value of the lane change permission flag XFLok to “1” for the left preceding vehicle. When the CPU makes a “No” determination in any of step 1118 and step 1120, the CPU transitions to step 1116. The CPU transitions to step 1124 from any of step 1114, step 1116, and step 1122.

Step 1124: The CPU determines whether or not a left rear vehicle (the determination target object in the RL region) is the high relative speed object. That is, the CPU determines whether or not the magnitude |VrRL| of a relative speed VrRL of the left rear vehicle is greater than the predetermined threshold relative speed Vrth. When the left rear vehicle is the high relative speed object, the CPU transitions to step 1126.

Step 1126: The CPU determines whether or not a TTC condition described below is established for the left rear vehicle. That is, the CPU first calculates the absolute value of a value acquired by dividing a distance DrRL between the left rear vehicle and the host vehicle by the relative speed VrRL of the left rear vehicle (=left rear vehicle ground speed−host vehicle ground speed) as a “time-to-collision TTC(RL) with respect to the left rear vehicle”. Next, the CPU determines whether or not the TTC condition with respect to the left rear vehicle is established by determining whether or not the time-to-collision TTC(RL) is longer than or equal to the threshold time period TTCth. When the relative speed VrFR has a negative value, the time-to-collision TTC(RL) is set to a value that is sufficiently greater than the threshold time period TTCth.

Step 1128: When the TTC condition with respect to the left rear vehicle is established, the CPU transitions to step 1128. The CPU calculates the inter-vehicle distance between the host vehicle and the left rear vehicle having an equal speed in each case in the same manner as the “case D and the case E”. When the calculated inter-vehicle distance is longer than or equal to the threshold inter-vehicle distance SKth, the CPU determines that the inter-vehicle distance condition is established, and transitions to step 1130.

Step 1130: The CPU determines whether or not an instantaneous distance condition with respect to the left rear vehicle is established. The instantaneous distance condition is a condition that is established when the left rear vehicle is not present on the laterally left side of the host vehicle. When the instantaneous distance condition with respect to the left rear vehicle is established, the CPU transitions to step 1132.

Step 1132: The CPU sets the value of a lane change permission flag XRLok to “1” for the left rear vehicle.

Step 1134: When the CPU makes a “No” determination in any of step 1126 to step 1130, the CPU transitions to step 1134 to set the value of the lane change permission flag XRLok to “0” for the left rear vehicle.

Step 1136: When the CPU in step 1124 determines that the left rear vehicle is not the high relative speed object (that is, the low relative speed object), the CPU transitions to step 1136 from step 1124 to determine whether or not a low relative speed object condition with respect to the left rear vehicle is established.

More specifically, as illustrated in the left diagram of FIG. 8B, the CPU extracts all objects (other vehicles) that are present within a region S7 which is a region within the host lane and the left lane and has an X axis coordinate greater than or equal to a value (−D3) acquired by inverting the sign of the “length D3” and less than or equal to “−Dlength”. As illustrated in the right diagram of FIG. 8B, the CPU determines whether or not at least one of the extracted objects is present within a region S8 that is a region within the host lane and the left lane and has an X axis coordinate greater than or equal to a value (−D4) acquired by inverting the sign of the “length D4” and less than or equal to “−Dlength”. When an object is not present in the region S8, the low relative speed object condition with respect to the left rear vehicle is established.

Step 1138: When the low relative speed object condition with respect to the left rear vehicle is established, the CPU transitions to step 1138 to determine whether or not an instantaneous distance condition with respect to the left rear vehicle is established. The process of step 1138 is the same as the process of step 1130.

Step 1140: When the instantaneous distance condition with respect to the left rear vehicle is established, the CPU transitions to step 1140 to set the value of the lane change permission flag XRLok to “1” for the left rear vehicle. When the CPU makes a “No” determination in any of step 1136 and step 1138, the CPU transitions to step 1134. The CPU transitions to step 1142 from any of step 1132, step 1134, and step 1140.

Step 1142: The CPU determines whether or not the value of the lane change permission flag XFLok is “1” for the left preceding vehicle and the value of the lane change permission flag XRLok is “1” for the left rear vehicle.

Step 1144: When the determination condition in step 1142 is established, the CPU transitions to step 1144 to set the value of a left lane change control permission flag (left LCS permission flag) XLLCok to “1”. Then, the CPU transitions to step 1195 to temporarily finish the present routine.

Step 1146: When the determination condition in step 1142 is not established, the CPU transitions to step 1146 to set the value of the left lane change control permission flag XLLCok to “0”. Then, the CPU transitions to step 1195 to temporarily finish the present routine.

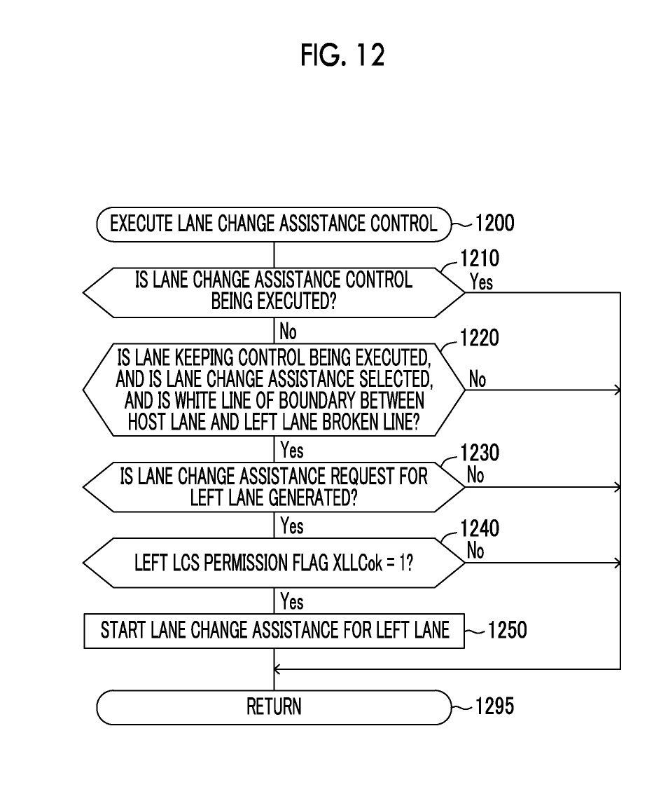

The CPU executes a “lane change assistance control execution routine” illustrated by a flowchart in FIG. 12 for each elapse of a predetermined time period. The routine is different from the routine illustrated in FIG. 10 in that the direction of changing the lane is leftward. Accordingly, hereinafter, the routine in FIG. 12 will be briefly described with focus on the difference from FIG. 10.

Step 1210: a step in which the same process as step 1010 is performed. When the lane change assistance control is currently not being executed, the CPU transitions to step 1220 from step 1210.

Step 1220: The CPU determines whether or not all of the following three conditions are established.

The lane keeping control is being executed.

The lane change assistance is selected by the operating switch 17.

The white line that is a boundary between the host lane and the left lane is a broken line.

Step 1230: When the determination condition in step 1220 is established, the CPU transitions to step 1230 to determine whether or not a lane change assistance request for the left lane is generated by operating the blinker lever.

Step 1240: When a lane change assistance request for the left lane is generated by operating the blinker lever, the CPU transitions to step 1240 to determine whether or not the value of the left lane change control permission flag XLLCok is set to “1”.

When the value of the left lane change control permission flag XLLCok is set to “1”, the CPU makes a “Yes” determination in step 1240 and transitions to step 1250 to start executing the lane change assistance control for the left lane. Then, the CPU transitions to step 1295 to temporarily finish the present routine. When the CPU makes a “Yes” determination in step 1210 or a “No” determination in any of step 1220 to step 1240, the CPU directly transitions to step 1295 to temporarily finish the present routine. Accordingly, when the value of the left lane change control permission flag XLLCok is “0”, the lane change assistance control is forbidden.

As described heretofore, when an object in the proximity of the host vehicle (proximal object) is the high relative speed object, the present embodied apparatus determines whether or not the lane assistance control should be forbidden in the circumstance around the host vehicle, by using the relative speed included in the object information detected by the proximity radar sensor 16a (refer to steps 408, 410, 426, 428, 1108, 1110, 1126, 1128). When the proximal object is the low relative speed object, the present embodied apparatus determines whether or not the lane assistance control should be forbidden in the circumstance around the host vehicle, by using the position (a distance and an azimuth) of the object included in the object information without using the relative speed included in the object information detected by the proximity radar sensor 16a (refer to steps 418, 420, 436, 438, 1118, 1120, 1136, 1138). Accordingly, even when an object of which the magnitude of the relative speed included in the object information is low is present in the proximity of the host vehicle, a determination as to whether or not to forbid the start of execution of the lane change assistance can be accurately performed.

The process of each step in FIG. 4, FIG. 10 (except for step 1050), FIG. 11, and FIG. 12 (except for step 1250) can be said to be executed by the assistance control forbidding unit 10B included in the CPU. The processes of step 1050 and step 1250 can be said to be executed by the control execution unit 10A included in the CPU.

The present disclosure is not limited to the embodiment and can employ various modification examples within the scope of the present disclosure. For example, step 412, step 430, step 1112, and step 1130 may be omitted.

In step 406 in FIG. 4, when the magnitude |VrFR| of the relative speed VrFR of the right preceding vehicle is greater than the predetermined threshold relative speed Vrth, the CPU of the driving assistance ECU 10 determines that the right preceding vehicle is the high relative speed object. When the right preceding vehicle is not present within the region S1 illustrated in the left diagram of FIG. 8A (in other words, when the distance between the front end portion of the host vehicle and the right preceding vehicle is longer than or equal to the front distance D1), the CPU may be configured to regard the right preceding vehicle as the high relative speed object regardless of the magnitude of the relative speed VrFR of the right preceding vehicle, make a “Yes” determination in step 406, and transition to step 408. When the distance between the host vehicle and the right preceding vehicle is long, the radar wave reflecting surface of the right preceding vehicle is unlikely to be significantly moved even when the magnitude of the relative speed of the right preceding vehicle is small. Accordingly, the proximity radar sensor 16a can accurately detect the relative speed of the right preceding vehicle.

Similarly, in step 424 in FIG. 4, when the magnitude |VrRR| of the relative speed VrRR of the right rear vehicle is greater than the predetermined threshold relative speed Vrth, the CPU of the driving assistance ECU 10 determines that the right rear vehicle is the high relative speed object. When the right rear vehicle is not present within the region S3 illustrated in the left diagram of FIG. 8A (in other words, when the distance between the rear end portion of the host vehicle and the right rear vehicle is longer than or equal to the rear distance D3), the CPU may be configured to regard the right rear vehicle as the high relative speed object regardless of the magnitude of the relative speed VrRR of the right rear vehicle, make a “Yes” determination in step 424, and transition to step 426. When the distance between the host vehicle and the right rear vehicle is long, the radar wave reflecting surface of the right rear vehicle is unlikely to be significantly moved even when the magnitude of the relative speed of the right rear vehicle is small. Accordingly, the proximity radar sensor 16a can accurately detect the relative speed of the right rear vehicle.

Similarly, in step 1106 in FIG. 11, when the magnitude |VrFL| of the relative speed VrFL of the left preceding vehicle is greater than the predetermined threshold relative speed Vrth, the CPU of the driving assistance ECU 10 determines that the left preceding vehicle is the high relative speed object. When the left preceding vehicle is not present within the region S5 illustrated in the left diagram of FIG. 8A (in other words, when the distance between the front end portion of the host vehicle and the left preceding vehicle is longer than or equal to the front distance D1), the CPU may be configured to regard the left preceding vehicle as the high relative speed object regardless of the magnitude of the relative speed VrFL of the left preceding vehicle, make a “Yes” determination in step 1106, and transition to step 1108. When the distance between the host vehicle and the left preceding vehicle is long, the radar wave reflecting surface of the left preceding vehicle is unlikely to be significantly moved even when the magnitude of the relative speed of the left preceding vehicle is small. Accordingly, the proximity radar sensor 16a can accurately detect the relative speed of the left preceding vehicle.

Similarly, in step 1124 in FIG. 11, when the magnitude |VrRL| of the relative speed VrRL of the left rear vehicle is greater than the predetermined threshold relative speed Vrth, the CPU of the driving assistance ECU 10 determines that the left rear vehicle is the high relative speed object. When the left rear vehicle is not present within the region S7 illustrated in the left diagram of FIG. 8A (in other words, when the distance between the rear end portion of the host vehicle and the left rear vehicle is longer than or equal to the rear distance D3), the CPU may be configured to regard the left rear vehicle as the high relative speed object regardless of the magnitude of the relative speed VrRL of the left rear vehicle, make a “Yes” determination in step 1124, and transition to step 1126. When the distance between the host vehicle and the left rear vehicle is long, the radar wave reflecting surface of the left rear vehicle is unlikely to be significantly moved even when the magnitude of the relative speed of the left rear vehicle is small. Accordingly, the proximity radar sensor 16a can accurately detect the relative speed of the left rear vehicle.

That is, the driving assistance ECU 10 may be configured to regard an object of which the magnitude of the relative speed included in the object information is less than or equal to the predetermined threshold relative speed and of which the position included in the object information is within a predetermined range from the host vehicle (for example, the region S1, the region S3, the region S5, or the region S7) as the low relative speed object, and determine whether or not the low relative speed object condition (in other words, one of the second execution permission conditions) for the low relative speed object is satisfied, by using the position (distance) included in the object information without using the relative speed included in the object information.

In the aspect of the present disclosed apparatus, each condition described below is set as “one of the conditions for establishing the second execution permission condition”.

(A) A condition that the position of the low relative speed object included in the object information is not within a region within the host lane between the front end portion of the host vehicle and a position ahead of the front end portion by a first distance (D2) (refer to the region S2 in the right diagram of FIG. 8A and the region S6 in the right diagram of FIG. 8B).

(B) A condition that the position of the low relative speed object included in the object information is not within a region within the adjacent target lane between the front end portion of the host vehicle and the position ahead of the front end portion by the first distance (D2) (refer to the region S2 in the right diagram of FIG. 8A and the region S6 in the right diagram of FIG. 8B).

(C) A condition that the position of the low relative speed object included in the object information is not within a region within the host lane between the rear end portion of the host vehicle and a position behind the rear end portion by a second distance (D4) (refer to the region S4 in the right diagram of FIG. 8A and the region S8 in the right diagram of FIG. 8B).

(D) A condition that the position of the low relative speed object included in the object information is not within a region within the adjacent target lane between the rear end portion of the host vehicle and the position behind the rear end portion by the second distance (D4) (refer to the region S4 in the right diagram of FIG. 8A and the region S8 in the right diagram of FIG. 8B).

(E) A condition that the position of the low relative speed object included in the object information is not within a region within the adjacent target lane between the front end portion and the rear end portion of the host vehicle (refer to the NG region in FIG. 7A and FIG. 7B).

In the aspect of the present disclosed apparatus, when the position of an object of which the magnitude of the relative speed included in the object information is less than or equal to the threshold relative speed is not in any of the region (S1, S5) between the front end portion of the host vehicle and a position ahead of the front end portion by the predetermined front distance (D1) and the region (S3, S7) between the rear end portion of the host vehicle and the position behind the rear end portion by the predetermined rear distance, the electronic control unit is configured to determine whether or not the object satisfies the first execution permission condition, by using at least the relative speed of the object included in the object information without determining whether or not the second execution permission condition is satisfied for the object (refer to each modification example in steps 406, 424, 1106, 1124).

Even when the relative speed of an object is lower than or equal to the threshold relative speed, the radar sensor can detect the relative speed of the object comparatively accurately when the object is away from the host vehicle. It is estimated that such an object does not have a large radar wave reflecting surface and that the radar wave reflecting surface is moved less. Accordingly, according to the aspect, when an object is the low relative speed object away from the host vehicle, a determination as to whether or not the first execution permission condition is satisfied is performed by using the relative speed of the object. Thus, a determination as to whether or not to permit execution of the lane change assistance control can be more accurately performed.

What is claimed is:

1. A driving assistance apparatus comprising:
a radar sensor configured to acquire object information for each proximal object that is an object being present in proximity of a host vehicle, the object information including a relative speed with respect to the host vehicle and a position with respect to the host vehicle; and
an electronic control unit configured to
execute lane change assistance control that controls a steering angle of the host vehicle to assist traveling of the host vehicle for changing a lane from a host lane to an adjacent target lane, the host lane being a lane in which the host vehicle is traveling, and the adjacent target lane being a lane adjacent to the lane in which the host vehicle is traveling,
determine whether or not the proximal object satisfies a first execution permission condition for permitting execution of the lane change assistance control, by using at least the relative speed included in the object information,
forbid execution of the lane change assistance control when the electronic control unit determines that the first execution permission condition is not satisfied,
determine whether or not a predetermined second execution permission condition is satisfied for a low relative speed object of which a magnitude of the relative speed included in the object information is less than or equal to a predetermined threshold relative speed, by using the position of the low relative speed object included in the object information without using the relative speed of the low relative speed object included in the object information, and
forbid execution of the lane change assistance control when the electronic control unit determines that the second execution permission condition is not satisfied.

2. The driving assistance apparatus according to claim 1, wherein the electronic control unit is configured to set, as one of conditions for satisfying the second execution permission condition, a condition that the position of the low relative speed object included in the object information is not within a region that is within the host lane between a front end portion of the host vehicle and a position ahead of the front end portion by a first distance.

3. The driving assistance apparatus according to claim 1, wherein the electronic control unit is configured to set, as one of conditions for satisfying the second execution permission condition, a condition that the position of the low relative speed object included in the object information is not within a region that is within the adjacent target lane between a front end portion of the host vehicle and a position ahead of the front end portion by a first distance.

4. The driving assistance apparatus according to claim 1, wherein the electronic control unit is configured to set, as one of conditions for satisfying the second execution permission condition, a condition that the position of the low relative speed object included in the object information is not within a region that is within the host lane between a rear end portion of the host vehicle and a position behind the rear end portion by a second distance.

5. The driving assistance apparatus according to claim 1, wherein the electronic control unit is configured to set, as one of conditions for satisfying the second execution permission condition, a condition that the position of the low relative speed object included in the object information is not within a region that is within the adjacent target lane between a rear end portion of the host vehicle and a position behind the rear end portion by a second distance.

6. The driving assistance apparatus according to claim 1, wherein the electronic control unit is configured to set, as one of conditions for satisfying the second execution permission condition, a condition that the position of the low relative speed object included in the object information is not within a region that is within the adjacent target lane between a front end portion and a rear end portion of the host vehicle.

7. The driving assistance apparatus according to claim 1, wherein for an object of which the magnitude of the relative speed included in the object information is less than or equal to the threshold relative speed and of which the position included in the object information is not in any of a region between a front end portion of the host vehicle and a position ahead of the front end portion by a predetermined front distance and a region between a rear end portion of the host vehicle and a position behind the rear end portion by a predetermined rear distance, the electronic control unit is configured to determine whether or not the object satisfies the first execution permission condition, by using at least the relative speed of the object included in the object information without determining whether or not the second execution permission condition is satisfied for the object.
